(19) United States
(12) Patent Application Publication
(10) Pub. No.: US 2003/0110071 A1
(43) Pub. Date: Jun. 12, 2003

(54) Talented person diagnosis supporting method, and talented person diagnosis supporting system

(76) Inventors: Taio Sugahara, Tokyo (JP); Koyu Mori, Tokyo (JP); Yoko Kaneko, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/312,755

(22) PCT Filed: Jun. 29, 2001
(86) PCT No.: PCT/JP01/05670

(30) Foreign Application Priority Data
Jun. 30, 2000 (JP) 2000-199954

(51) Int. Cl. G06F 17/60

(52) U.S. Cl. 705/8

(57) ABSTRACT

A human resource diagnosis support method and human resource diagnosis support system are provided as including a database functioning section 23 with a storing means that preliminarily stores a limited human resource average value corresponding to an average resulting from a numeric conversion of answers as a result of questioning operations made to a limited number of plural human resources (such as a top business leader) whereby when diagnosing an applicant upon receipt of a diagnosis request received from an applicant terminal 10 connected via a communication network, questionary information indicative of the same questioning contents as those of the questioning operations is sequentially transmitted to permit the plural answers to be numerically converted to calculate an examinee sum value for permitting a deviation value of the examinee sum value to be calculated whereupon a diagnosed result is prepared in contrast between the limited plural human resources and the examinee and transmitted to a client enterprise terminal 30 via the communication network.

### TECHNICAL FIELD

The present invention relates to a human resource diagnosis supporting method and a human resource diagnosis support system that execute diagnosis of an applicant in response to a diagnosis request from an enterprise or the applicant to provide a client enterprise with a diagnosis result.

### BACKGROUND ART

When an enterprise employs a human resource, there are many instances where a personnel affairs staff undertakes interviews or examinations a plurality of times to determine an employment. During such a process, there are many probabilities in which an employment process includes an elimination method that allows the number of candidate employees to be decreased from all the applicants in a stepwise manner each time the interviews and examinations are repeated a number of times for thereby determining an adopted employee in a final interview.

It is a current practice for an enterprise of interest to undertake various measures such as, for instance, with a view to employing a further excellent human resource, referring to a club activity or an interview for a fresh graduate whereas a past outcome or the interview for a candidate to be employed in the middle for thereby qualitatively discriminating a qualification of the candidate to determine a propriety of adoption in a consideration of the presence of or the absence of a balanced sense as an enterprise staff.

Especially, in a business field, since an individual sensitivity that contributes to an outcome in operation has a greater specific weight than in other occupational categories, it is required to use an employment process to meet such a demand. However, when adopting a human resource associated with the business field, existing situations appear with no tool or know-how that enable discrimination of an appropriate capability of the candidate required for performing operation in the business filed.

Under such a related art status quo set forth above, when adopting an excellent businessperson for the enterprise, more specifically, the enterprise tends to be suffered from various probabilities listed below.

First, it is pointed out that an employment standard in the business standard is unclear. That is, when employing the human resource belonging to the business field, since there are many probabilities in which an employment standard on which an employment affairs staff relies is different from a general standard related to a field of operation, a client and a management man, the judgment standard for the businessperson inevitably becomes vague. Consequently, there are many instances where the related art employment process is apt to follow the former judgment standard left in an original state, resulting in an issue to cause a difficulty in achieving a standardized employment of the human resources.

Secondly, it is pointed out that unevenness exists in employment standards of interviewers. Namely, since there are many probabilities in that during an oral examination, the interviewer tends to execute the employment judgment according to his subjective point of view, a disparity is caused in the employment judgment for each interviewer, with a resultant development of inclination in the employed human resources.

Thirdly, it is pointed out that it takes much time and labor required for determining employment. That is, in the related art practice, a number of interviews are repeatedly conducted until the employment is completed, resulting in an issue of a difficulty in saying that the employment judgment is efficiently carried out.

Fourthly, it is pointed out that there exists a limit in a process for conducting the human resource judgment in a primary oral examination. When employing the businessperson, there are many probabilities in that a large number of applicants inevitably apply to the primary oral examination. As a consequence, there are many instances in which the oral examination inevitably relies on the eliminating method such that a difficulty is encountered in recognizing the human resource with a prominent capability in a short time period while, at the same time, there are many instances where a difficulty is encountered in the applicant per se in emphasizing his original capability.

Further, another issue is encountered in that if a large number of applicants apply for a planned number of employees, the management man per se is unable to directly have the oral examination with all the applicants, resulting in a situation in that even when the employee has been finally adopted, the adopted employee is unable to comply with the business field.

### DISCLOSURE OF INVENTION

The present invention has been proposed with the above view in mind and has an object of the present invention to provide a human resource diagnosis supporting method and a human resource diagnosis support system that enable a human resource, desired by an enterprise, to be obtained in a short period of time.

In order to address the issues set forth above, a first aspect of the present invention conserns a method of supporting a human resource diagnosis, comprising the steps of preliminarily storing static information, indicative of information representing human resource diagnosing factors of an examinee for an objective to be diagnosed, and field-evaluated information indicative of an enterprise inside field-evaluation of an examinee in an enterprise and representing the human resource diagnosing factors, inputting a plurality of retrieving conditions, and comparing the plurality of inputted retrieving conditions with the static information and the field-evaluated information to provide a screen with names of relevant examinees in compliance with the static information and the field-evaluated information that match the retrieving conditions, a list of static information and field-evaluated information of the relevant examinees and an average value of human resource diagnosing factors of at least one of the relevant examinees provided in the list.

Here, “static information” includes results of various examinations, for serving as an index for diagnosing the human resource, involving, for instance, a linguistic ability test, a capability diagnosis test and an aptitude diagnosis test or the like.

Further, an attempt may be made to provide a matrix, a ranking, a radar chart and a distribution diagram for a plurality of human resources in a linked relationship with static information and field-evaluated information that match the retrieving conditions.

A second aspect of the present invention concerns the supporting method of the first aspect and comprises the steps of providing the screen with a list of the static information and the field-evaluated information associated with a an examinee selected from among a plurality of examinees, and a display of an average value of the human resource diagnosing factors of at least one of selected examinees, and enabling selectable examinees to be altered for altering the list of static information and field-evaluated information and an average value of the human resource diagnosing factors of at least one of the examinees displayed in the list in response to the selectable examinees being altered.

A third aspect of the present invention concerns the supporting method of the second aspect and comprises the steps of preliminarily storing static information and field-evaluated information of a plurality of examinees forming a group, and providing an average value of human resource diagnosing factors of at least one of the examinees displayed in the list.

Here, the above-described “group” includes an organization (such as a division or a section) of the enterprise and, in addition thereto, a group for each generation and all other groups such as an upper rank or lower rank class in outcome in the enterprise.

A fourth aspect of the present invention concerns the supporting method of the first or second aspect, wherein when preliminarily storing a limited human resource average value, that forms an average resulting from numeric conversion of answers as a result of questioning a limited number of human resources, in storage means whereupon diagnosing the applicant in response to receipt of a diagnosing request from a client unit which is operated by the applicant via a communication network, the method comprising sequentially transmitting questionary information, indicative of the same questioning content as that of the questioning step, to the client unit and sequentially receiving a plurality of answers associated with the questionary information to convert the plural answers in a numeric value for calculating a sum value of the examinees, and calculating a deviation value of the sum value of the examinees in terms of the limited human resource average value stored in the storage means and preparing a diagnosis result, contrasting the limited number of plural human resources and the examinee, to be stored as the human resource diagnosing factors.

Here, the “questionary information” includes all kinds of questions, for achieving the human resource diagnosis, such as a questionnaire and various kinds of questions provided by the enterprise.

A fifth aspect of the present invention concerns the supporting method of the fourth aspect, wherein the step of storing the human resource diagnostic factors is executed by calculating evaluation points of a plurality of kinds in dependence on the answers from the applicants.

A sixth aspect of the present invention concerns the supporting method of the fourth aspect, wherein the limited human resources include employees belonging to the client company and an average value resulting when numerically converting the answers as the result of questioning the employees are stored in the storage means as the limited human resource average value.

A seventh aspect of the present invention concerns the supporting method of the fourth aspect, wherein the limited human resources includes human resources who have upper rank outcomes in a business field and an average value resulting when numerically converting the answers as the result of questioning the relevant human resources are stored in the storage means as the limited human resource average value.

An eighth aspect of the present invention concerns the supporting method of the fourth aspect, wherein when executing the questioning step, questionary information for diagnosing a business potential and a business sense is provided to the applicant.

A ninth aspect of the present invention concerns the supporting method of the eighth aspect, wherein the questionary information includes business potential diagnosing questions to enable diagnosis of the business potential, and sense diagnosing questions to enable diagnosis of the business sense, whereby when preparing the diagnosis result, a deviation value based on answers to the business potential diagnosing questions and a deviation value based on answers to the sense diagnosing questions are calculated whereupon the relationship between the deviation value of the business potential diagnosing questions and the deviation value of the sense diagnosing questions are plotted on a graph.

A tenth aspect of the present invention concerns the supporting method of the ninth aspect, wherein the potential diagnosing questions include questions for each category to enable diagnosis of the business potential for each category, and the sense diagnosing questions include questions for each category to enable diagnosis of the business sense for each category such that when preparing the diagnosis result, a deviation value is calculated for each category on the basis of answers associated with the diagnosing questions for each category.

An eleventh aspect of the present invention concerns the supporting method of the eighth aspect, wherein the diagnosed result, represented in the graph indicative of the relationship between the deviation value of the business potential and the deviation of the business sense, and the diagnosis result inclusive of the diagnosis result obtained by calculating the deviation value for each category on the basis of the answers to the diagnosing questions for each category.

A twelfth aspect of the present invention concerns the supporting method of the fourth aspect, wherein the storage means stores an average value of the answers, which are converted into a numeric value, obtained by implementing the questioning step in a past, an average value of the answers, which are numerically converted, obtained by implementing the questioning step for a limited human resource, and an average value of the answers, which are converted into the numeric value, obtained by implementing the above questioning step for a further limited human resource, with the diagnosis result being prepared using respective average values.

A thirteenth aspect of the present invention concerns the supporting method of the fourth aspect and comprises the steps of storing information related to a registered client enterprise to be available for viewing with the client unit operated with the applicant, and providing the enterprise, which the applicant desires to apply for, with the diagnosis result.

A fourteenth aspect of the present invention concerns a human resource diagnosis support system, comprising storage means for storing at least static information, indicative of information representing human resource diagnosing factors of an examinee for an objective to be diagnosed, and field-evaluated information indicative of an evaluation of the examinee in an enterprise and representing the human resource diagnosing factors, input means for inputting a plurality of retrieving conditions, and providing means for comparing the plurality of input retrieving conditions with the static information and the field-evaluated information to provide a screen with names of relevant examinees in compliance with the static information and the field-evaluated information that match the retrieving conditions, a list of static information and field-evaluated information of the relevant examinees and an average value of the human resource diagnosing factors of at least one of the relevant examinees provided in the list.

A fifteenth aspect of the present invention concerns the human resource diagnosis support system, wherein the providing means allows a screen to be provided with a list of the static information and the field-evaluated information of the applicants selected from among a plurality of examinees, and an average value of the human resource diagnosing factors of at least one of the selected examinees, and the selectable examinees are alternated to permit the list of the static information and the field-evaluated information to be altered and an average value of the human resource diagnosing factors of at least one of the examinees displayed in the list in response to the selectable examinees being altered.

A sixteenth aspect of the present invention concerns a human resource diagnosis support system having a human resource diagnosing support device, a client enterprise device and a client device, which is operated with an applicant seeking to apply to a client enterprise, that are connected to one another via a communication network, comprising a client device including operational input means to be operated with the applicant, transmitting and receiving means for transmitting and receiving information to and from the human resource diagnosis support system, and viewing means for viewing various information, transmitting and receiving means for transmitting and receiving information to and from the client enterprise device and the client device, storing means for storing information related to the client enterprise, and viewing means and a client enterprise device to allow a client enterprise to view a diagnosis result diagnosed with the human resource diagnosis support device, and a human resource diagnosis support device including transmitting and receiving means for transmitting and receiving information between the client device and the client enterprise device, storing means for storing a limited human resource average value that is an average value resulting from answers, that are converted into numeric values, obtained when applying questionary information indicative of questionary contents for diagnosing an applicant, client enterprise information related to the client enterprise and questions indicative of the questionary information to a limited number of plural human resources, and control means that sequentially transmits questionary information stored in the storing means in response to a diagnosis request from the client device and sequentially receives answers with respect to the questionary information to calculate an examinee sum value by numerically converting a plurality of answers for thereby calculating a deviation value of the examinee sum value in terms of the limited human resource average value stored in the storing means whereupon a diagnosis result with a contrast between the limited number of plural human resources and the examinee is prepared which is transmitted to the client enterprise device via the communication network.

### BRIEF DESCRIPTION OF DRAWINGS

FIG. 1 is a block diagram illustrating a structure of a human resource diagnosis support system to which the present invention is applied.

FIG. 2 is a view illustrating the basic sequence of operations, of the human resource diagnosis support system to which the present invention is applied, wherein a client enterprise is provided with a diagnosis result upon receipt of a diagnosis request.

FIG. 3 is a view illustrating the basic sequence of operations, of the human resource diagnosis support system to which the present invention is applied, wherein operation proceeds to execute questioning operations upon receipt of application made by an applicant.

FIG. 4 is a view illustrating the basic sequence of operations, in which when executing the questioning operations in a diagnosis functioning section, a display screen is provided to an applicant terminal with the human resource diagnosis support system to which the present invention is applied.

FIG. 5 is a view illustrating the basic sequence of operations that are implemented in the human resource diagnosis support system, to which the present invention is applied, when preparing the diagnosed result using data obtained through the questioning operations.

FIG. 6 is a view illustrating the basic sequence of operations that are implemented in the human resource diagnosis support system, to which the present invention is applied, when preparing a pool constant and a sea constant using data obtained through the questioning operations.

FIGS. 7A and 7B are views illustrating constant matrixes when sea constant database and pool constant database are prepared in the human resource diagnosis support system, to which the present invention is applied.

FIG. 8 is a view illustrating a PS-deviation flowchart when a P-deviation value and an S-deviation value are calculated using the pool constant in the human resource diagnosis support system to which the present invention is applied.

FIG. 9 is a view illustrating a PS-deviation flowchart when the P-deviation value and the S-deviation value are calculated using the sea constant in the human resource diagnosis support system to which the present invention is applied.

FIG. 10 is a view illustrating a category chart when a deviation value is calculated for each category in the human resource diagnosis support system to which the present invention is applied.

FIG. 11 is a flowchart illustrating the basic sequence of operations that are implemented in the human resource diagnosis support system, to which the present invention is applied, when preparing a diagnosed result for each examinee using a top constant.

FIG. 12 is a flowchart illustrating the basic sequence of operations that are implemented in the human resource diagnosis support system, to which the present invention is applied, when preparing diagnosed results of applicants inclusive of a plurality of applicants using the sea constant and the pool constant.

FIG. 13 is a view illustrating how the diagnosed result is provided to a client enterprise terminal in the human resource diagnosis support system to which the present invention is applied.

FIGS. 14A, 14B and 14C are views illustrating display screens, to be provided to an agent functioning section of a client enterprise terminal for allowing a client enterprise to execute a company registration, registration of employment information and registration of a recruiting meeting, respectively, in the human resource diagnosis support system, to which the present invention is applied.

FIGS. 15A and 15B are views illustrating display screens, to be provided to the applicant terminal for allowing the applicant to view the registered client enterprise with the applicant terminal and to select a plurality of client enterprises, respectively, in the human resource diagnosis support system, to which the present invention is applied.

FIGS. 16A to 16D are views illustrating how the diagnosis results are provided to the client enterprise terminal in the human resource diagnosis support system, to which the present invention is applied.

FIG. 17 is a view illustrating the content of static information database stored in the client enterprise terminal.

FIG. 18 is a view illustrating the content of field-evaluated information database stored in the client enterprise terminal.

FIG. 19 is a view illustrating a screen to be provided to a personnel affairs party when inputting retrieving conditions.

FIG. 20 is a view illustrating a screen to be provided to the personnel affairs party in the presence of a plurality of examinees that comply with the retrieving conditions.

FIG. 21 is a view illustrating how static information, matrixes ad radar charts are altered and provided when carrying out personal changes.

### BEST MODE FOR CARRYING OUT THE INVENTION

An embodiment of the present invention is described hereinafter with reference to the drawings.

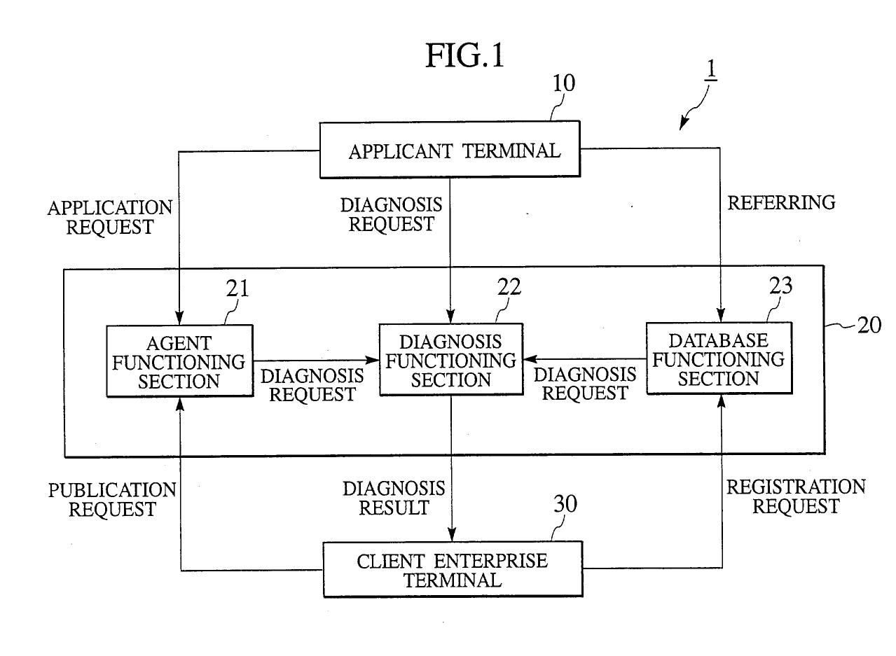

The present invention is applied to a human resource diagnosis talent evaluation support system as shown in FIG. 1.

The human resource diagnosis support system 1 is comprised of an applicant terminal 10, a human resource diagnosis support apparatus 20 and a client enterprise terminal 30, which are connected via a communication network such as an Internet.

The applicant terminal 10 is comprised of a personal computer that is operated by an applicant for application to a client enterprise to prepare information of various kinds to be transmitted to the human resource diagnosis support apparatus 20. The applicant terminal 10 has an operational inputting function such as a keyboard and a mouse to enable the user to operate, a display function for providing the user with various contents, a computing function for enabling various computations to be executed responsive to the operated content, a memory function for storing various information, and a transmitting and receiving function for achieving transmission and reception of information with the human resource diagnosis support apparatus 20 via the communication network.

The client enterprise terminal 30 is comprised of a personal computer, which is operated by a personnel affairs staff or the like who belong to the client company. The client enterprise terminal 30 has an operational inputting function such as a keyboard and a mouse to enable the person in charge of personnel management to operate, a display function for providing the personnel affairs staff, with various contents, a computing function for enabling various computations to be executed responsive to the operated content, a memory function for storing various information, a transmitting and receiving function for achieving transmission and reception of information with the human resource diagnosis support apparatus 20 via the communication network, and a reading function to allow an evaluation result and an application status or the like to be read out at the human resource diagnosis apparatus 20.

The human resource diagnosis support apparatus 20 has an agent functioning section 21, a diagnosis functioning section 22 and a database functioning section 23, with respective functioning sections 21, 22, 23 being connected with the applicant terminal 10 and the client enterprise terminal 30 via the communication network such as the Internet.

The human resource diagnosis support apparatus 20 is configured to execute a questioning operation in a flow pattern to permit questioning information to be transmitted to the applicant via the communication network and answer information relevant to the questioning information to be received from the applicant to perform evaluation of information content on the basis of answer information obtained in the questioning operation to permit a resource evaluation service to be performed for providing the same to the client enterprise terminal 30. The human resource diagnosis support apparatus 20 prepares an evaluation result; obtained by numerically expressing answer information resulted from the questioning operation, as one human resource diagnosis factor. The human resource diagnosis factor includes not only the diagnosis result but also static information such as school careers and overseas experiences of respective evaluators, and field-evaluated information, such as an achieved rate, a personnel performance factor evaluation and grades appearing in a situation where the respective evaluators belong to the client company.

The diagnosis functioning section 22 executes evaluation of the applicant who operates the applicant terminal 10 and provides the client enterprise terminal 30 with evaluation result information. The diagnosis functioning section 22 obtains the diagnosis result by executing computation using answer information and information of various kinds stored in the database functioning section 23, with diagnosis result information being transmitted to the client enterprise terminal 30 to permit the diagnosis result for viewing.

In practice, the diagnosis functioning section 22 prepares diagnosis result information specific for diagnosing a business sense and business potential required in a business section. As a factor (a category) for enabling diagnosis of the business sense, there are an outcome principle, a trade sense, a business sharpness, a concentration ability, a coordinating ability and a viewpoint or the like. Also, as a factor (a category) for diagnosing the business potential, there are a gaming sense, a personal magnetism, a star property, a spiritual strength, a habit and a self-recognition or the like. The diagnosis functioning section 22 prepares questions as questioning information for enabling diagnosis of the various factors set forth above.

While diagnosis result information prepared with the diagnosis functioning section 22 is herein described with reference to an exemplary case using the business sense and the business potential, it is to be understood that the diagnosis result information may involve other factors such as static information and field-evaluated information or the like or may involve a question content including a linguistic ability diagnosis, various questionnaires and various examinations. Further, while the diagnosis functioning section 22 is exemplarily described below in connection a graph with the business sense being plotted on an X-axis and the business potential being plotted on a Y-axis, the diagnosis result information may be prepared in such a way to enable the personnel affairs staff to set other static information or field-evaluated information, linguistic ability diagnosis, various questionnaires and the various examinations on the X-axis with the Y-axis remaining under a condition to be freely set. That is, diagnosis result information may include not only the business potential and the business sense, which are described below, but also may include all the human resource diagnosing factors that are used as parameters to be plotted on a graph.

The database functioning section 23 serves to prepare and store database with various constants that are converted into database for enabling comparison with answer information obtained with the diagnosis functioning section 22. The database functioning section 23 stores a P (Potential)-average value and P-standard deviation associated with the business potential as well as an S (Sense)-average value and an S-standard deviation associated with the business sense. Further, the database functioning section 23 operates to cause various factors, forming the above-described business sense and the business potential, to be classified as categories and holds a category-based average value for each category and a category-based standard deviation for each category. Also, it is to be noted that the P-average value and the S-average value are totally referred to as a PS-average value in the following description.

Upon receipt of a registration request from the client enterprise terminal 30, the database functioning section 23 classifies and stores the above-described PS average value and standard deviations while classifying and storing the above-described category based average value and the category-based standard deviation.

The database functioning section 23 stores: a limited range constant database (hereinafter referred to as pool constant database) that includes the PS-average value and the category average database (hereinafter referred to as pool constants) resulting from answer information, in reply to the questions, by the human resource related to a limited range (for instance, a type of business, a term and a company); a limited range constant database (hereinafter referred to as sea constant database) that includes the PS-average value and the category average database (hereinafter referred to as sea constants) resulting from answer information, in reply to the questions, by examinees (the human resources) related to a wider range than the above-described limited range; and top constant database (hereinafter referred to as top constant database) that includes the PS-average value and the category average database (hereinafter referred to as top constants) resulting from answer information, in reply to the questions by higher rank experienced persons with their high rank records of performance in respective individuals.

Further, the database functioning section 23 obtains information related to the name of the company of the client enterprise terminal 30, each industry and the human resource with the higher-ranked outcome in an experience of a manager. When this takes place, the database functioning section 23 prepares a constant matrix and stores the pool constant, the sea constant and the top constant in correlation with the constant matrix.

With such a human resource diagnosis support system 1, when the diagnosis functioning section 22 receives a diagnosis request from the applicant terminal 10, the diagnosis functioning section 22 executes the questioning operations for transmitting the various questions to the applicant terminal 10 and receiving answer information with respect to questionnaire information.

Subsequently, the human resource diagnosis support apparatus 20 performs diagnosing operation using answer information obtained in the questioning operations. Upon completing the diagnosing operation, the human resource diagnosis support apparatus 20 transmits a diagnosis result, obtained by executing diagnosis operation, as diagnosis result information to the client enterprise terminal 30. Also, the human resource diagnosis support apparatus 20 executes updating operation of the content of database using answer information.

During the diagnosis operation, the diagnosis functioning section 22 converts the answer, obtained in the questioning operations set forth above, in a numeric value and calculates a deviation value referring to various constant database stored in the database functioning section 23 to prepare the calculated deviation value as diagnosis result information.

The agent functioning section 21 has a function to receive publication requests from a plurality of client enterprise terminals 30 which are not shown and place information, related to the client enterprise that accepts the publication request, into a condition for viewing. The agent functioning section 21 has an internal memory means that stores enterprise information database and has database of information related to the enterprise for which the publication request is made.

Upon receipt of an application request from the applicant terminal 10 through which reference is made to information, rendered available for viewing, that is associated with a particular client enterprise, the agent functioning section 21 transmits the application request to the client enterprise terminal 30. In response to the application request being transmitted, the agent functioning section 21 outputs a diagnosis request to the diagnosis functioning section 22. Upon receipt of the diagnosis request, the diagnosis functioning section 22 initiates the above-described questioning operations and the diagnosing operation to provide diagnosis result information, which in turn is transmitted to the client enterprise to which the publication request is made.

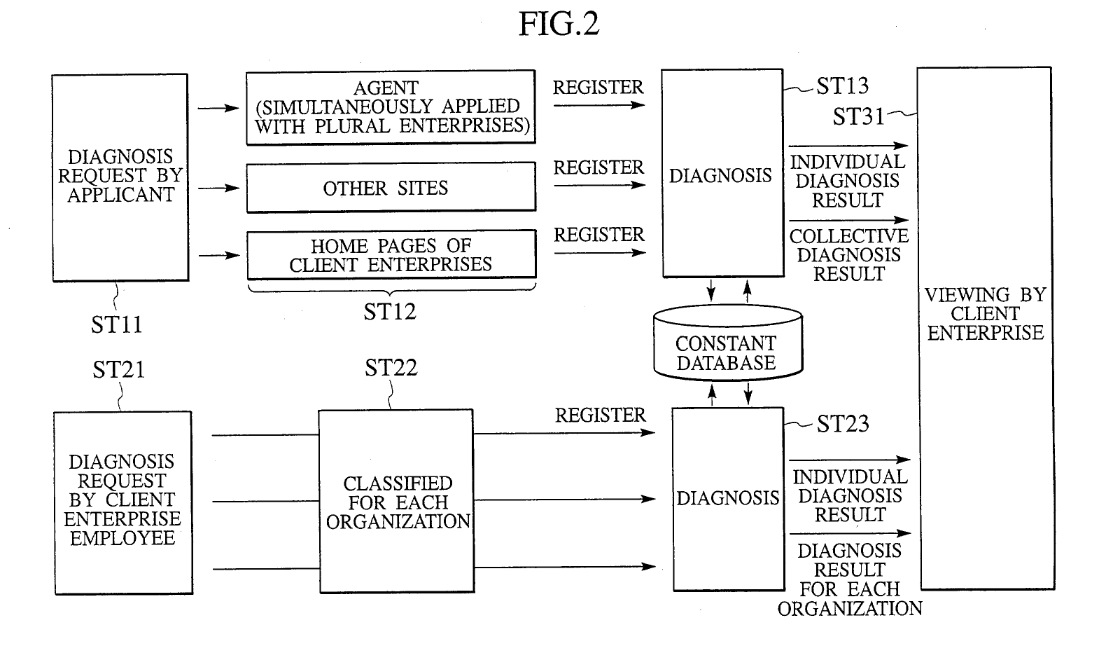

Now, the content of operations to be executed in the human resource diagnosis support system with such a structure is described below in detail with reference to FIG. 2 the contents of operations to be performed in a sequence between the application, made by the applicant who operates the applicant terminal, and the provision of the diagnosis result to the client enterprise.

As shown in FIG. 2, with the human resource diagnosis support system, first, if the applicant terminal 10 accesses the agent functioning section 21, other site or a client enterprise home page available for viewing with the agent functioning section 21 (step ST11), the flow is routed to the questioning operations to be performed with the diagnosis functioning section 22 (step ST12) under a situation where the respective sites are registered for the diagnosis service. When this takes place, the diagnosis operation is executed with reference to answer information resulting from the questioning operations and various constant database (step ST13) to provide an individual diagnosis result for each applicant and a collective diagnosis result based on collected diagnosis results of a plurality of applicants, with the individual diagnosis result and the collective diagnosis result being transmitted to the client enterprise terminal 30. This results in a capability for the client enterprise terminal 30 to allow the individual diagnosis results of the respective applicants and the collective diagnosis result associated with the plural applicants to be placed for viewing (step ST31).

Under such a situation, the diagnosis functioning section 22 may be configured to supply answer information to the database functioning section 23 to update the contents of the pool constant and the sea constant of the database functioning section 23. With such configuration, the client enterprise terminal 30 obtains the individual diagnosis result, relevant to the applicant, and the diagnosis results of all the applicants, which are provided to the personnel affairs staff (step ST31).

In the meantime, if an employee of the client enterprise, which is registered for the diagnosis service, applies for the diagnosis service (step ST21), then the diagnosis functioning section 22 classifies the relevant employee for each organization (for instance, a company, a division and an outcome) (step ST22) and executes the questioning operations and the diagnosing operation (step ST23). When this takes place, the diagnosis functioning section 22 executes the diagnosing operation referring to answer information and various constant database to provide an individual diagnosis result for each employee and the collective diagnosis result which in turn are transmitted to the client enterprise terminal 30. I it to be noted here that the diagnosis functioning section 22 may be configured to prepare not only the diagnosis result for each employee but also to prepare a diagnosis result for each group composed of a plurality of human resources or a diagnosis result for each group selected and prepared by the organization or the personnel affairs staff.

Further, the diagnosis functioning section 22 may be so arranged as to supply answer information to the database functioning section 23 to update the content of various constant database of the database functioning section 23. With such an arrangement, the client enterprise terminal 30 provides the personnel affairs staff with the diagnosis result for each individual related to the employees of the enterprise and the diagnosis results of all the examinees (step ST31).

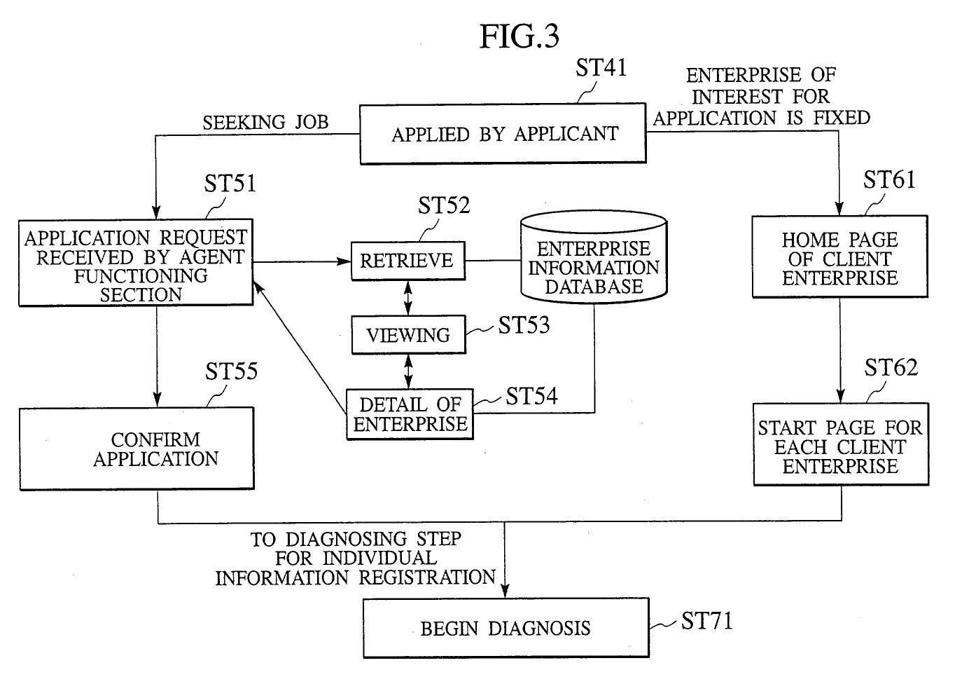

Now, the basis sequence of operations, between the application made by the applicant and the above-described questioning operations, to be performed in the human resource diagnosis support system with such a structure is described below in detail with reference to FIG. 3.

In FIG. 3, first in step ST41, the applicant terminal 10 executes operation to transmit an application request to the agent functioning section 21 in response to the applicant's operation, or to transmit the application request (a diagnosis request) to the human resource diagnosis support apparatus 20 with a particular enterprise being designated.

Subsequently, upon receipt of the application request (of interest for seeking a job) with no designation for a particular objective enterprise (step ST51), the agent functioning section 21 executes operation for retrieving a designated company (step ST52).

During such operation, by referring to enterprise information database prepared in response to a plurality of publication requests, the agent functioning section 21 transmits display data to the applicant terminal 10 (step ST53) for permitting the applicant to view a list of the names of the enterprises involved in enterprise information database.

Next, if a detail of a particular enterprise, involved in the list of display, from the applicant terminal 10, then the agent functioning section 21 obtains detailed enterprise information, indicative of a detailed content of the particular enterprise, from enterprise information database (step ST54) and executes transmission of the detail of the particular enterprise to provide the same to the applicant. In this instance, the agent functioning section 21 recognizes the name of the enterprise, for the objective to be applied, to which the applicant applies while recognizing the names of the enterprises of interest to which the applicant desires to apply.

In consecutive step, the agent functioning section 21 executes operation to confirm that the applicant applies for the plural enterprises in a case where the applicant designates the plural enterprises (step ST55). When this takes place, the agent functioning section 21 transmits display data to the applicant terminal 10 to provide a list of the names of the enterprises for the objectives of interest and commences the abode-described questioning operations and diagnosing operation in response to information indicating of an availability to be offered from the applicant terminal 10 (step ST71).

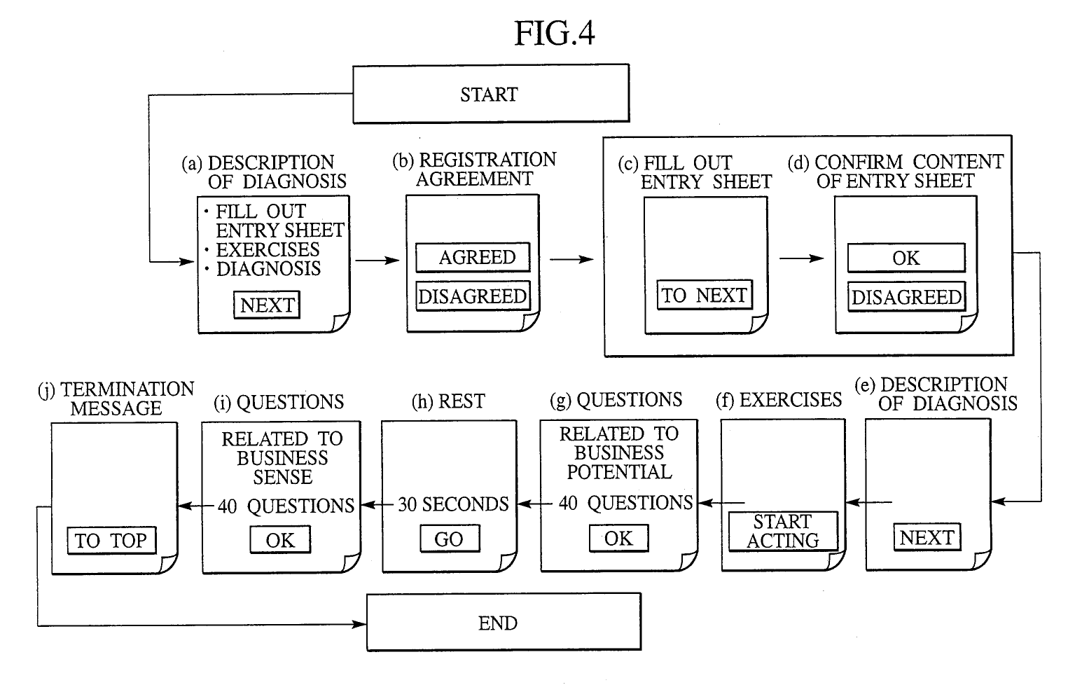

On the other hand, when receiving the application request with a particular enterprises being designated for the objective of interest from the applicant terminal 10, the agent functioning section 21 controls the applicant terminal 10 such that the display is jumped to the home pages of the client enterprises (step ST61). Here, the respective home pages of the relevant enterprises are published with descriptions each related to the above-mentioned diagnosis service, and a diagnosis start page is provided to the applicant for commencing the diagnosis service (step ST62). Then, upon receipt of the diagnosis request, for accepting the diagnosis service provided by the human resource diagnosis support apparatus 20, transmitted from the applicant terminal 10, the human resource diagnosis support apparatus 20 commences the abode-described questioning service and diagnosis operation (step ST71). Now, a detailed description is given below with reference to FIG. 4 for the basic sequence of operations to provide a display screen to the applicant terminally when executing the above-described questioning operations and diagnosis operation associated with the applicant with the human resource diagnosis support apparatus 20.

As shown in FIG. 4, when a diagnosis request is inputted with the applicant terminal 10 or the agent functioning section 21, the diagnosis functioning section 22 commences the above-described diagnosis service to transmit display data to the applicant terminal 10 for providing a display of a diagnosis description screen to describe the content of the diagnosis service shown in FIG. 4(a). The display data of the diagnosis description screen provided by the diagnosis functioning section 22 includes the content associated with the diagnosis service, such as how to fill out an entry sheet to input individual information of the applicant and to conduct exercises to be ready for the questioning operations.

As shown in FIG. 4(b), next, the diagnosis functioning section 22 transmits display data to the applicant terminal 10 to provide a display of a registration agreement screen, representing the content of a registration rule related to the diagnosis service, to the applicant who desires to accept the diagnosis service. Upon receipt of information related to the registration rule being agreed, the flow of the diagnosis functioning section 22 is routed to a next step.

As shown in FIG. 4(c), subsequently, the diagnosis functioning section 22 transmits display data to the applicant terminal 10 for providing a display of the entry sheet with an input column to allow the above-described individual information to be filled out. It is to be noted here that individual information includes a name of the applicant, male or female, a mail address, an address and a telephone number, etc. Further, the entry sheet may include other input columns, such as a school career, a name of school, a name of a faculty, a name of a subject of study, a motive of desire, own dream and own strength, etc. specifically for a fresh graduate. In addition, the entry sheet may include other input columns for the entry of a name of a company to which the applicant currently (or previously) belongs, a currently (or previously) assigned division, a number of years for currently (or previously) continuous service, a current (or previous) income and an experienced occupational category in the past.

Subsequently, the diagnosis functioning section 22 transmits display data to the applicant terminal 10 for providing a display of an agreement screen to obtain an agreement of the applicant with respect to the content of the entry sheet, and the flow proceeds to a next step responsive to information indicative of the entry sheet being agreed.

As shown in FIG. 4(e), next, the diagnosis functioning section 22 transmits display data to the applicant terminal 10 for providing a display to illustrate how the applicant conducts the diagnosis service.

As shown in FIG. 4(f), subsequently, the diagnosis functioning section 22 transmits display data to the applicant terminal 10 to allow the applicant to conduct the exercises to be ready for answering the question, and upon completion of the exercise, the flow is routed to a next step.

As shown in FIG. 4(g), subsequently, the diagnosis functioning section 22 transmits display data to the applicant terminal 10 for providing a display of a questioning content screen to allow the business potential of the applicant to be diagnosed and executes the questioning operation by implementing operation to sequentially transmit display data to the applicant terminal 10 for displaying a subsequent questioning content when receiving answer information from the applicant terminal 10 or after a given time interval has elapsed. This results in a capability for the diagnosis functioning section 22 to sequentially obtain answer information with respect to respective questions related to the business potential.

As shown in FIG. 4(h), if the diagnosis functioning section 22 discriminates that answer information related to a given number of questioned contents is received, then the diagnosis functioning section 22 transmits display data to the applicant terminal 10 for providing a display of a display screen to allow the applicant to take a rest for a given time interval.

As shown in FIG. 4(i), subsequently, the diagnosis functioning section 22 transmits display data to the applicant terminal 10 for providing a display of a question content screen to allow the business sense of the applicant to be diagnosed and executes the questioning operation by implementing operation to sequentially transmit display data to the applicant terminal 10 for displaying a subsequent question content when receiving answer information from the applicant terminal 10 or after a given time interval has elapsed. This results in a capability for the diagnosis functioning section 22 to sequentially obtain answer information with respect to respective questions related to the business sense.

Thus, the diagnosis functioning section 22 provides the applicant with the whole questioned contents and, if answer information with respect to the questions is obtained, then as shown in FIG. 4(j), the diagnosis functioning section 22 transmits display data to the applicant terminal 10 for notifying the applicant with an end message to close the questioning operation.

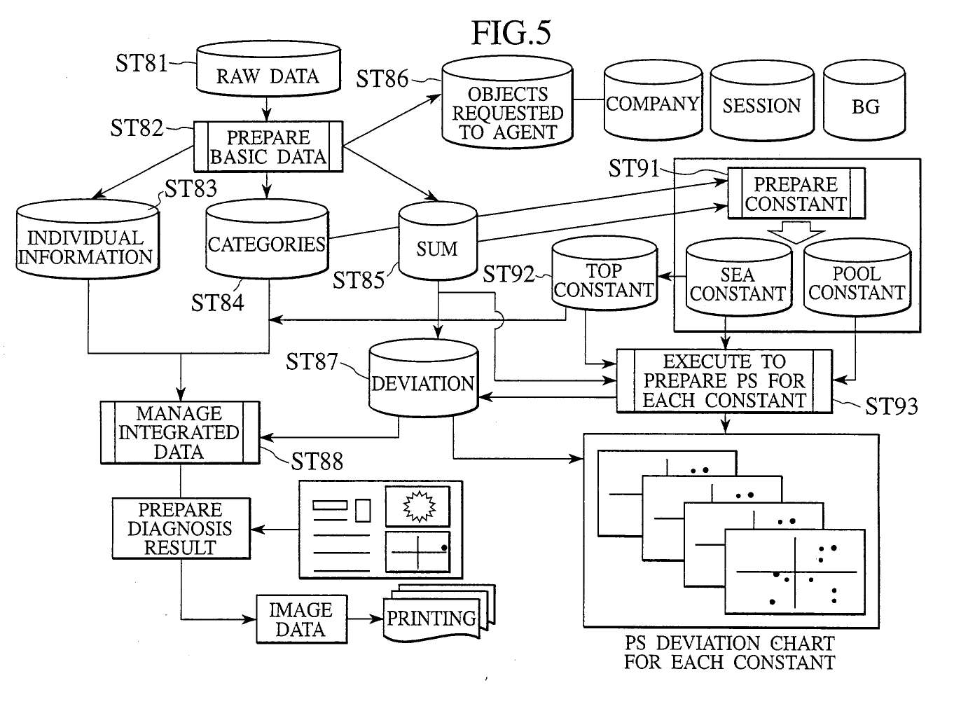

Now, a detailed description is given below with reference to FIG. 5 for a dataflow for preparing pool constant database and sea constant database, using answer information resulting from the above-described questioning operations shown in FIG. 4, to prepare a diagnosis result.

Individual information and answer information resulting the above-described questioning operations are inputted to the human resource diagnosis support apparatus 20 and stored in the memory means of the human resource diagnosis support apparatus 20 as raw data (step ST81). Then, stored raw data is subjected to basic data preparation step (step ST82) to permit individual information, numerically converted values of the answers for each category and a sum of these numeric values to be stored (steps ST 83, ST84 and ST85). Also, during execution of the basic data preparing operation (step ST82), if the name of the particular enterprise is designated as an objective to be applied, the particular enterprise is stored for each company, each session (a term of employment) and each business group (BG) (step ST86). In particular, the terminology “session” refers to management segments of units such as a first time, a second time and additional recruitment when recruiting fresh graduates.

The value stored in step ST85 as the PS-sum of the values is then subjected to the constant preparing operation to store the same as pool constant database and sea constant database in the agent functioning section 21 (step ST91).

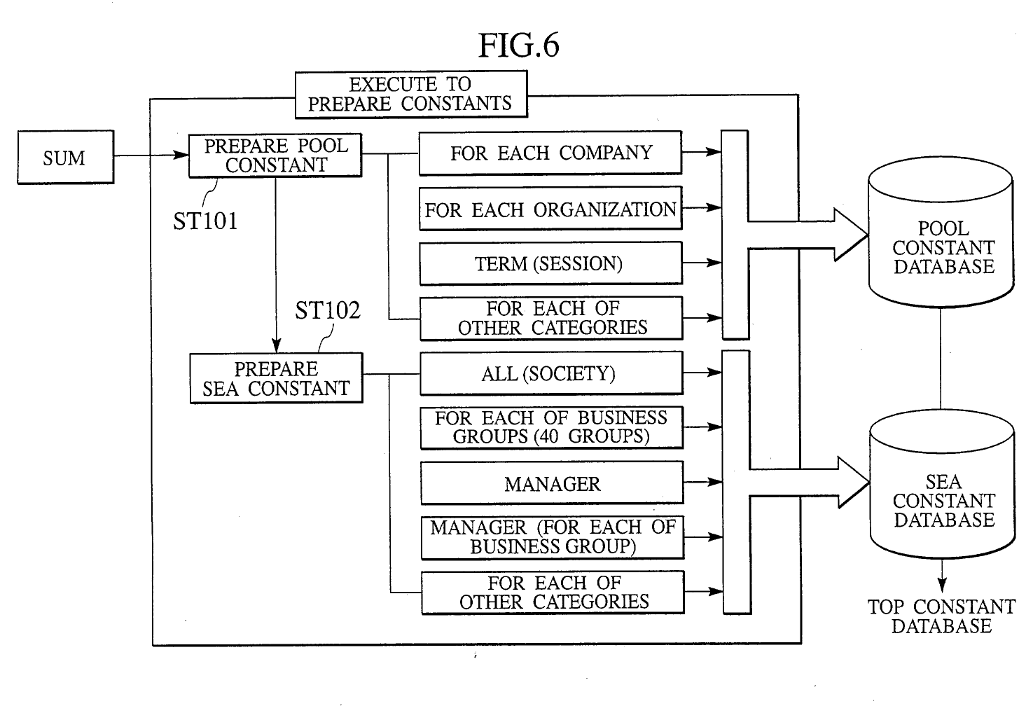

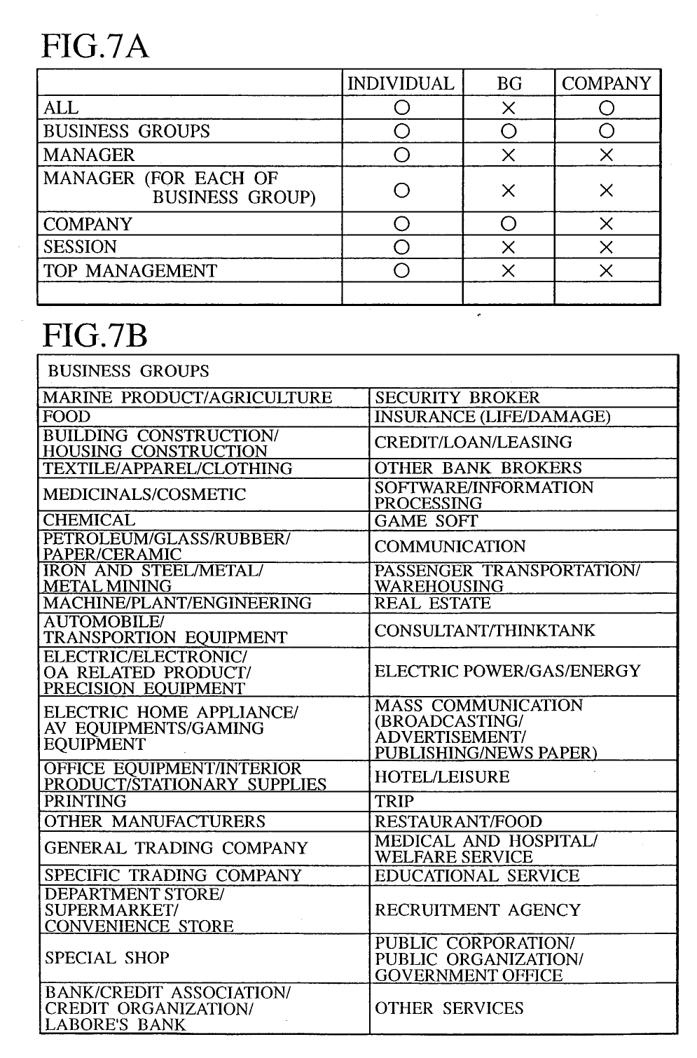

The sum of the values in such a constant preparing operation is subjected to pool constant preparing operation for preparing the pool constant as shown in FIG. 6 (step ST101). Further, the sum of the values is classified according to a constant matrix shown in FIG. 7 and involved in pool constant database to be stored. As a result, the agent functioning section 21 updates a PS-average value (pool constant) in pool constant database.

Further, the sum of the values is subjected to the sea constant preparing operation to prepare the sea constant (step ST102) and classified as the sea constant according to the constant matrix to be involved in sea constant database for storage. As a result, the agent functioning section 21 updates the PS-average value (see constant) in the sea constant database. Also, a portion of the sea constant stored in sea constant database is stored as a top constant (step ST92).

The resulting top constant is used for executing a constant based deviation preparing operation to allow a deviation value of the sum of the values, stored in step ST85, to be calculated (step ST93). Thus, a PS-deviation chart is obtained when comparing the PS average value as parameters of the pool constant, the sea constant and the top constant.

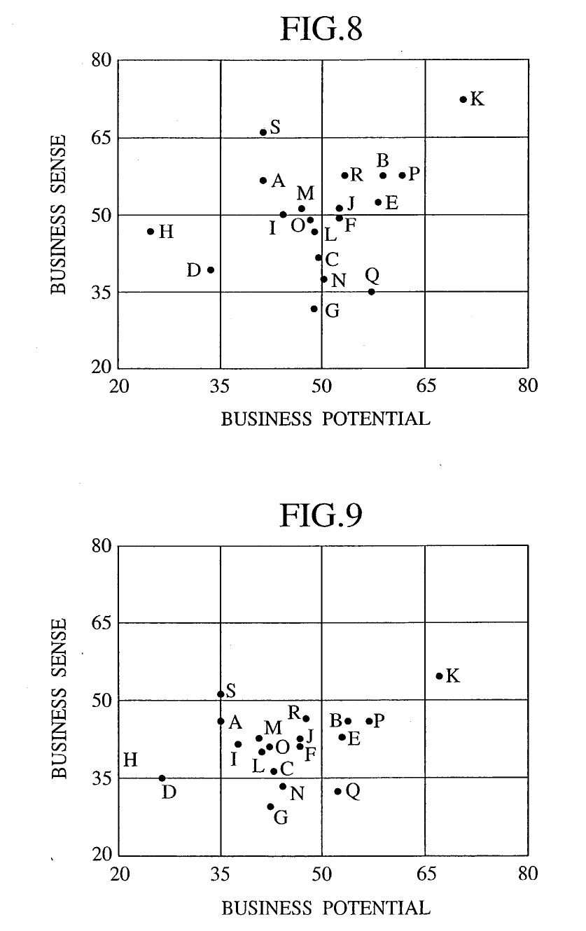

As shown in FIG. 8, more particularly, when preparing the PS-deviation chart using the sea constant, the PS-deviation chart is plotted for each individual applicant by taking the deviation value, derived when diagnosing the business potential, on the horizontal axis while taking the deviation value, derived when diagnosing the business sense, on the vertical axis.

According to the PS-deviation chart shown in FIG. 8, it is possible to provide the client with a distribution pattern of the deviation values of the business potentials and the business senses of the plural applicants. On the other hand, when prepared the PS deviation chart using the sea constant or the top constant, as shown in FIG. 9, it appears that the deviation value of the business potential and the deviation potential of the business sense vary (i.e., decrease) even for the same applicant “K”.

Now a detail of a case where the top constant is employed is described below.

A comparison is made between the sum of the values stored in step ST 85 and the top constant stored in the above-described step ST92 and the PS deviation value is stored (step ST88).

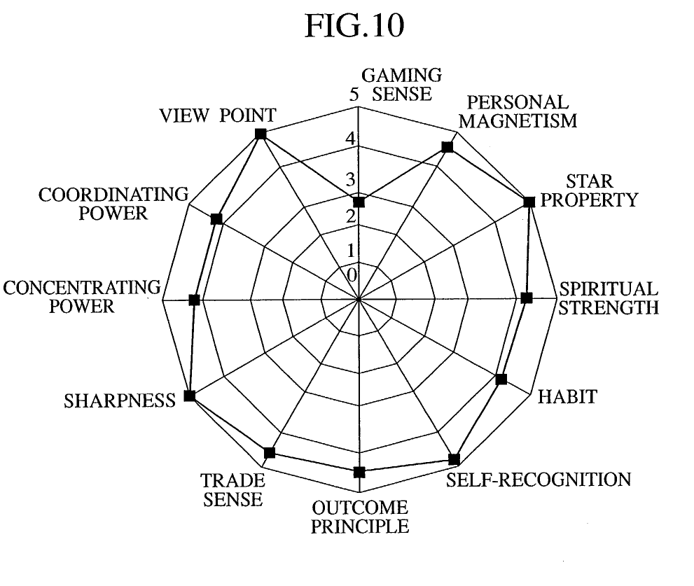

Subsequently, the diagnosis functioning section 22 implements a coupled data management using individual information stored in step ST83, the values for respective categories stored in step ST84 and the PS deviation value stored in step ST87. When this takes place, the values for the respective categories stored in step ST84 are used for calculating the deviation values using the top constants for the categories. That is, the diagnosis functioning section 22 manages the deviation values for the respective categories using the top constants and the PS-deviation value in correlation with individual information to provide an individual diagnosis result that enables individual information, the deviations values for the respective categories and the PS-deviation value to be totally provided. As shown in FIG. 10, the deviation values for the respective categories can be expressed as a category chart in five ranks for each factor forming the business chance and the business sense set forth above.

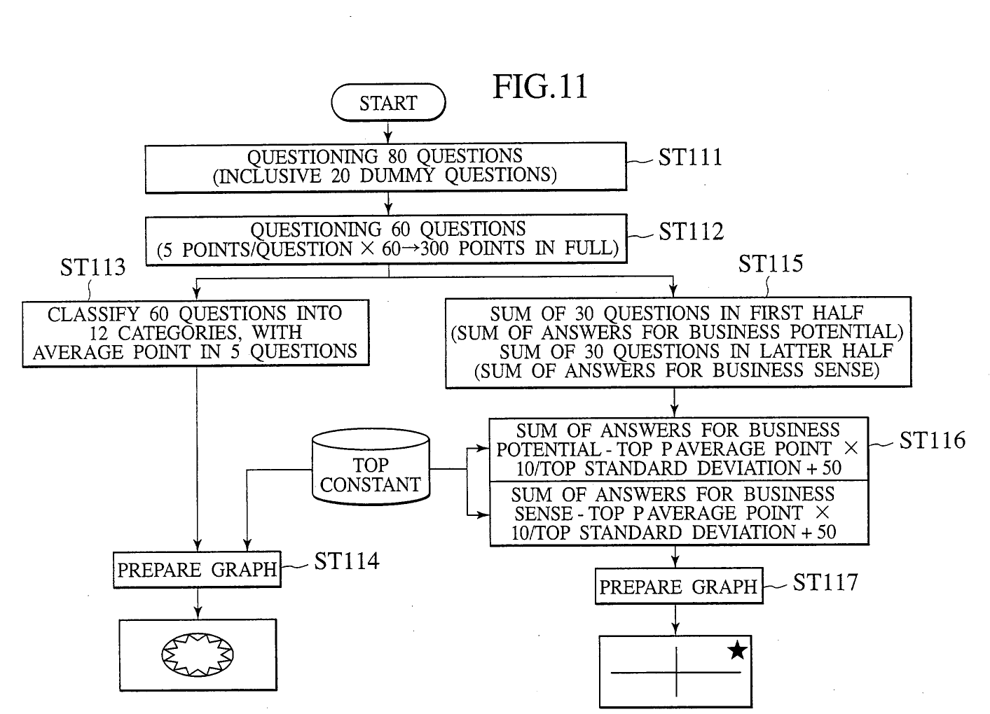

Now, operation of the diagnosis functioning section 22 for preparing the above-described individual diagnosis result is described in greater detail with reference to FIG. 11.

In the flowchart shown in FIG. 11, the diagnosis functioning section 22 executes the questioning operations set forth above by transmitting questionary information, indicative of, for instance, eighty questions (inclusive of twenty dummy questions), to the applicant terminal 10 in a sequential fashion while receiving answer information indicative of answers to the questions (step ST111). When this takes place, the diagnosis functioning section 22 takes answer information, associated with the sixty questions except for the dummy questions, as information for preparing the diagnosis result (step ST112).

Subsequently, the diagnosis functioning section 22 classifies answer information for each category with respect to the sixty questions, thereby calculating a average point among the answers in a numeric value for the five questions when classifying answer information into exemplary twelve categories (step ST113). That is, the diagnosis functioning section 22 obtains a category average value for each applicant.

Next, the diagnosis functioning section 22 obtains the deviation value using the category average value, retrieved from top constant database of the database functioning section 23 for each category, and the resulting category average value obtained in step ST113, thereby preparing the category chart shown in FIG. 10 in a manner as set forth above (step ST114).

On the other hand, when preparing the PS-deviation charts shown in FIGS. 8 and 9, the diagnosis functioning section 22 obtains a P-total value resulting from numeric conversion of the answers with respect to thirty questions in a first half for diagnosing the business potential and an S-total value resulting from numeric conversion of the answers with respect to thirty questions in a latter half for diagnosing the business sense (step ST115).

Subsequently, the diagnosis functioning section 22 obtains a P-deviation value using the P-average value, retrieved from top constant database of the database functioning section 23, while obtaining an S-deviation value using an S-average value, retrieved from top constant database of the database functioning section 23, and the S-total value obtained in step ST115 (step ST116).

Consecutively, the diagnosis functioning section 22 prepares the deviation charts shown in FIGS. 8 and 9 using the P-deviation value and the S-deviation value (step ST117).

With the human resource diagnosis support system incorporating the diagnosis functioning section 22 operative to perform such operations, since it is possible to prepare the diagnosed result of the examinee using the top constant that is preliminarily prepared, a diagnostic evaluation of the applicant in terms of the top experienced hand can be provided to the client enterprise terminal 30.

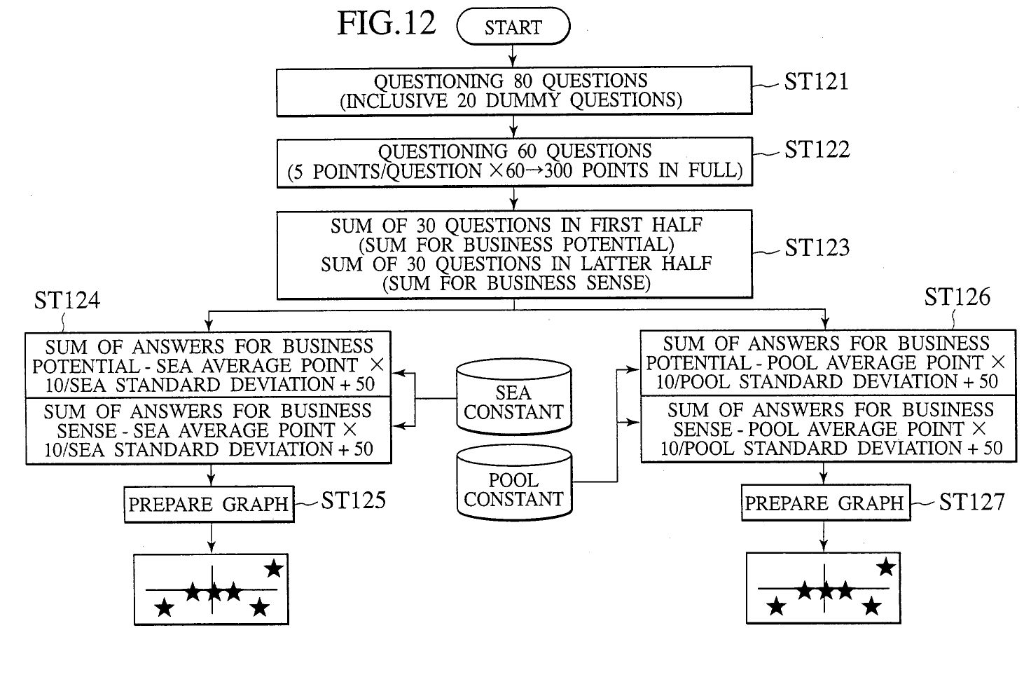

Now, the basic sequence of operations of the diagnosis functioning section 22 for preparing diagnosis results by diagnosing a plurality of applicants when receiving application requests from the plural applicants is described in greater detail with reference to FIG. 12.

In the flowchart shown in FIG. 12, the diagnosis functioning section 22 executes the questioning operations set forth above by sequentially transmitting questioning information, indicative of, for instance, eighty questions (inclusive of twenty dummy questions), to the applicant terminals 10 (step ST121) while receiving a plurality of answer information indicative of answers to the questions. When this takes place, the diagnosis functioning section 22 takes answer information, associated with the sixty questions except for the dummy questions, as information for preparing the diagnosis results (step ST122).

Subsequently, when preparing the PS-deviation charts including diagnosis among the plural applicants, the diagnosis functioning section 22 obtains a P-total value, resulting from numeric conversion of the answers with respect to the thirty questions in a first half for diagnosing the business potentials, and an S-total value, resulting from numeric conversion of the answers with respect to the thirty questions in the latter half for diagnosing the business sense, for each examinee (step ST123).

Next, when diagnosing the plural examinees by referring to the sea constant, the flow of the diagnosis functioning section 22 proceeds to step ST124, where a P-deviation value is obtained for each examinee using the P-average value, retrieved from the sea constant database, and the P-total value calculated in step ST123 whereas an S-deviation value is obtained for each examinee using the S-average value, retrieved from the sea constant database, and the S-total value calculated in step ST123 (step ST124).

Subsequently, the diagnosis functioning section 22 prepares the deviation charts shown in FIGS. 8 and 9 using the P-deviation values and the S-deviation values of all examinees (step ST125).

On the other hand, when diagnosing the plural examinees by referring to the pool constant, the flow of the diagnosis functioning section 22 proceeds to step ST124, where a P-deviation value is obtained for each examinee using the P-average value, retrieved from the pool constant database, and the P-total value calculated in step ST123 whereas an S-deviation value is obtained for each examinee using the S-average value, retrieved from the pool constant database, and the S-total value calculated in step ST123 (step ST126).

Here, the diagnosis functioning section 22 may retrieve the pool constant by referring to the constant matrix upon, for instance, obtaining the type of occupation or the name of the company which the examinee desires to apply. Thus, the diagnosis functioning section 22 is enabled to obtain the diagnosis result specified for the type of occupation which the applicant desires for thereby providing the client enterprise terminal 30 with such a diagnosis result.

In addition, the diagnosis functioning section 22 may retrieve the pool constant by referring to the constant matrix in response to the diagnosis content requested by the client enterprise terminal 30. With such operation, the diagnosis functioning section 22 is able to obtain the diagnosis result responsive to the demand of the client company terminal 30 to perform diagnosing operation of the examinee in dependence on such a particular demand.

Subsequently, the diagnosis functioning section 22 prepares the deviation charts shown in FIGS. 8 and 9 using the P-deviation values and the S-deviation values of all examinees (step ST127).

With the human resource diagnosis support system incorporating the diagnosis functioning section 22 operative to perform such operations, since it is possible to prepare the diagnosis result of the applicant using the sea constant and the pool constant that are preliminarily prepared, diagnosis results of the plural examinees depending on the constant matrix can be provided to the client enterprise terminal 30.

With such a human resource diagnosis support system, further, if, for instance, there is a single examinee, then the operation as shown in FIG. 11 is executed to provide the client enterprise terminal 30 with the diagnosis result and, on the contrary, if there are a plurality of examinees, then operation is executed in a manner as shown in FIG. 12 to implement the diagnosing operation using the plural constants, thereby enabling the diagnosis results in terms of various view points to be provided to the client enterprise terminal 30. It is of course to be understood that, even in the presence of the plural examinees, it is possible to perform the operation shown in FIG. 11 and, in the presence of the single examinee, it is possible to perform the operation shown in FIG. 12.

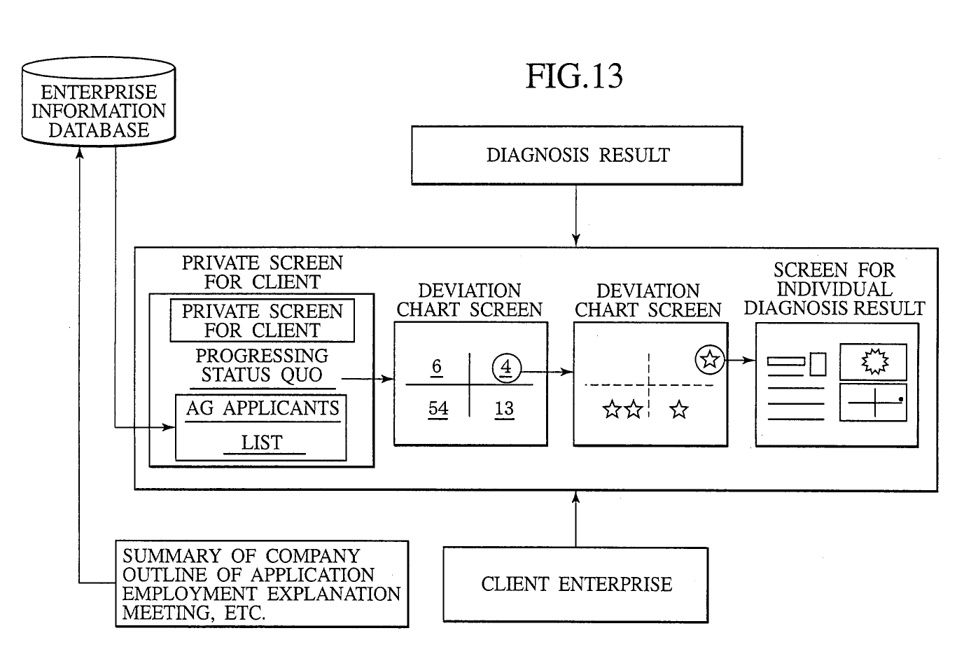

Now, the basic sequence of operations of the diagnosis functioning section 22 for providing the client enterprise limited 30 with the diagnosis results prepared in a manner set forth above is described in greater detail with reference to FIG. 13.

In the flowchart shown in FIG. 13, the agent functioning section 21 is applied with registering information, such as an outline of a company, essential points of recruitment and information related to a recruitment explanation meeting, that are preserved as company information database to allow the applicant terminal 10 to view at any time.

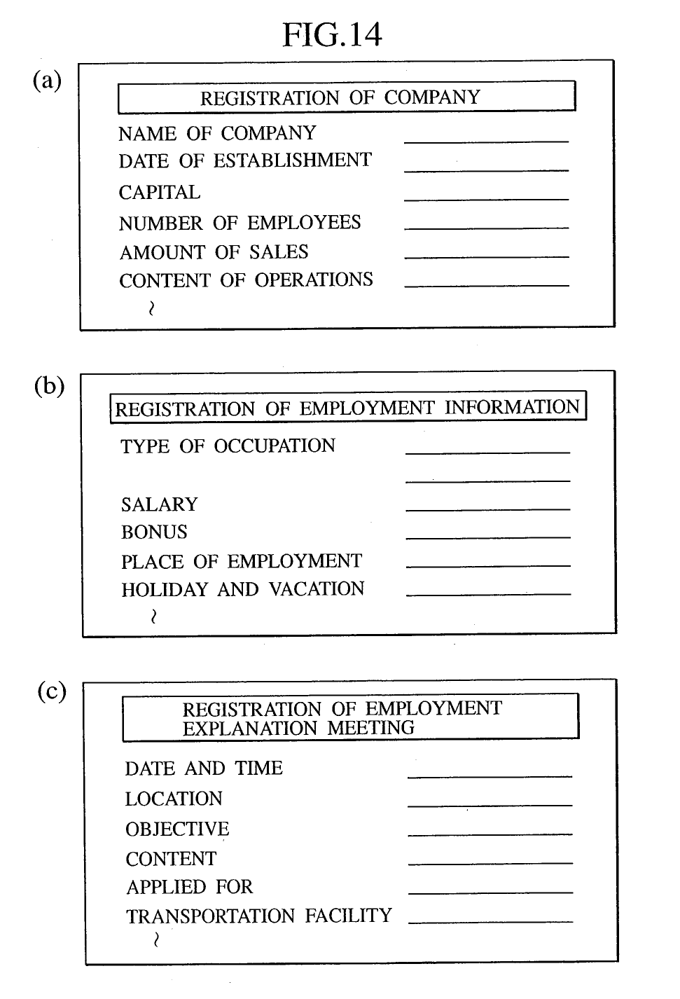

Here, if the client enterprise terminal 30 issues a publication request to the agent functioning section 21, the agent functioning section 21 transmits a display screen to the client company terminal 30 for permitting a company to be registered as shown in FIG. 14A when preparing information to be provided to the applicant terminal 10. As shown in FIG. 14A, the agent functioning section 21 supplies display data input columns, to permit the name of a company, the date of establishment, a capital, the number of employees, the amount of sales and a content of operations or the like, to the client enterprise terminal 30 to permit information inputted for respective input columns to be transmitted to the applicant terminal 10 at any time.

Further, the agent functioning section 21 displays an employment information registering screen to enable registration of employment information as shown in FIG. 14B. As shown in FIG. 14B, the agent functioning section 21 supplies display data, involving input columns for permitting the client enterprise terminal 30 to input a type of occupation, a content of work, a salary, a bonus, a place of employment and a holiday and vacation or the like, to the client enterprise terminal 30 to allow information inputted for respective input columns to be transmitted to the applicant terminal 10 at any time.

In addition, the agent functioning section 21 transmits a display screen to the client enterprise terminal 30 to permit information related to the recruitment meeting as shown in FIG. 14C. As shown in FIG. 14C, the agent functioning section 21 supplies display data, involving input columns for permitting the client enterprise terminal 30 to input a time, a location, an objective, a content, an application and a transportation facility or the like, to the client enterprise terminal 30 to allow information inputted for respective input columns to be transmitted to the applicant terminal 10 at any time.

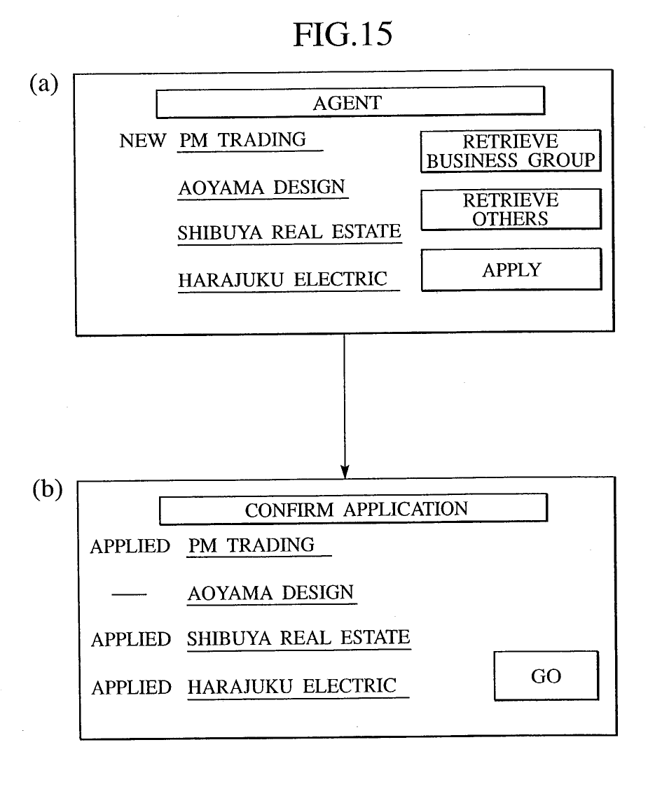

Under such a condition, if the agent functioning section 21 is applied with the publication request from the client enterprise terminal 30 while receiving information related to the outline of the company, the essential points of recruitment and information related to the recruitment explanation meeting, the agent functioning section 21 permits the applicant terminal 10 to view a display of a list of the client enterprise, to which the publication requests are made, as shown in FIG. 15A. Under such a situation, the agent functioning section 21 transmits information, related to the outline of the relevant company and the essential points of recruitment, to the applicant terminal 10 at any time if desired such that when an application request occurs, an application checking display is provided as shown in FIG. 15B to assist the applicant to proceed to the diagnosing operation.

Under such a condition, if a particular client enterprise is applied with the applicant who is viewing and the diagnosing service is provided to the client enterprise terminal 30, the agent functioning section 21 outputs the diagnosis request to the diagnosis functioning section 22.

Upon receipt of answer information associated with the above-described questioning operations, the diagnosis functioning section 22 prepares display data for providing a display of the diagnosis result screen. In response to the referring request from the client enterprise terminal 30, the diagnosis functioning section 22 transmits display data to the client enterprise terminal 30 for displaying a private screen for the client, the deviation chart screen and the diagnosis resulting screen for each applicant.

The diagnosis functioning section 22 transmits display data to the client enterprise terminal 30 for providing a list of display for the applicants to the agent to provide information of the applicants who apply the application requests to the agent functioning section 21. Upon selection of a progressed status, the diagnosis functioning section 22 transmits display data to the client enterprise terminal 30 for displaying the deviation chart screen in which a resulting distribution of the questioning operations is expressed in a figure whereupon when the figure in the deviation chart is selected, the diagnosis functioning section 22 transmits display data to the client enterprise terminal 30 for displaying the deviation chart expressed in the selected figure. Upon selection of plots indicative of individual applicants contained in the deviation charts, the diagnosis functioning section 22 displays a screen involving individual information, the deviation value for each category and the deviation chart for each applicant expressed in the selected plot.

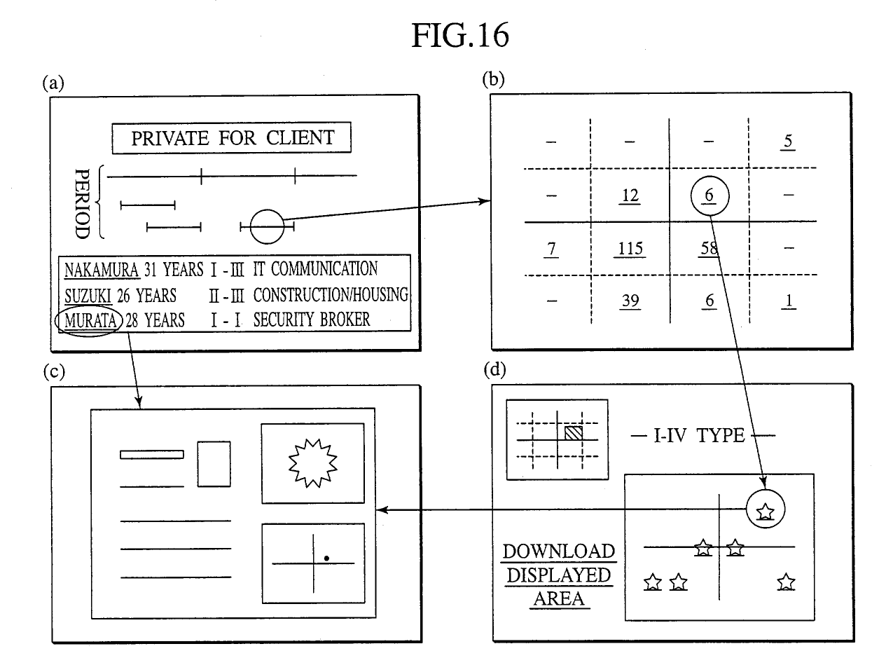

More particularly, further, the diagnosis functioning section 22 provides a display of a private screen for the client as shown in FIG. 16A. As shown in FIG. 16A, the diagnosis functioning section 22 may be configured to provide a display of a period, in which the applicant is diagnosed, the name of the examinee, the age of the examinee, a region of the deviation chart and the type of industry. When permitting the client enterprise terminal 30 to view such display data, for instance, if a viewer belonging to the client enterprise chooses the period, then the PS-deviation chart of the examinee of interest for the objective to be diagnosed in the period shown in FIG. 16B is displayed. Then, if the figure of the number of the examinees contained in FIG. 16B is chosen, the diagnosis functioning section 22 displays the applicant distribution (see FIG. 16D) in the selected region. If the display of the plot or the name of the applicant for each examinee is chosen, the individual diagnosis result shown in FIG. 16C is displayed. In this manner, the human resource diagnostic support apparatus 20 is able to provide the client enterprise terminal 30 with the diagnosis result obtained in the above-described questioning operations and the diagnosing operation.

With the human resource diagnostic support system with such a structure set forth above, when determining an acceptable employee among a large number of applicants, performing the above-described operations enables the business senses and the business potentials of those applicants to be diagnosed, resulting in a capability of providing the client enterprise terminal 30 with the diagnosed result. According to such a human resource diagnostic support system, since the database functioning section 23 prepares the top constant database that is used for comparison with answer information to enable the applicant to be diagnostically evaluated, a more realistic diagnostic evaluation of the applicant is realized. Namely, with such a human resource diagnosis support system, it is possible to implement comparison between the applicant and an average value of all the applicants, comparison between the applicant and an average value of the other persons except for the applicant and a comparison between the applicant and an average value of the top-ranked human resources in a particular type of occupation, it is possible to precisely diagnose the business senses and the business potentials of the applicants.

As a consequence, with the human resource diagnosis support system, there is a lessened need for determining the personal affairs, with a plurality of examinations and interviews, for the human resources related to, for instance, a business section. That is, according to the human resource diagnosis support system, it is possible to diagnose the applicant regardless of indefiniteness in a standard in a personal affairs change for businesspersons for each personal affairs staff and it is further possible to preclude a biased choice in determining employments of human resources due to uneven employment standards of interviewers. Accordingly, executing the diagnosing operation based on a preliminary diagnosing service allows the time and the labor required for altering the personal affairs to be minimized while providing a capability of adopting an excellent human resource in a short period of time.

Further, the presence of the agent functioning section 21 provided in the human resource diagnosis support system enables the applicant terminal 10 to view the plural client enterprise terminals 30, to which the diagnosis service is provided such that once the applicant is subjected to the questioning operations merely at one time, the diagnosis result of the applicant can be provided to the registered plural client enterprise terminals 30.

Also, while the present invention has been described with reference to one example set forth above wherein the questioning operations and the diagnosing operation are performed for the applicant who is seeking to find employment to the client enterprise or the employee belonging to the client enterprise, it may be modified so as to implement comparison between diagnostic resulting information of the applicant and an employment result of the personal affairs staff who has had an interview with the applicant to diagnose the degree of biased judgment of the personal affairs staff. Namely, an attempt can be made to study which of the business sense and the business potential the personal affairs staff takes a serious view or which of the categories is seriously counted when taking an interview upon comparison between the adopted applicant and the diagnosis result of the applicant.

Next, a human resource diagnosis support system of other embodiment is described below.

With the human resource diagnosis support system of the presently filed embodiment, performing the questioning operations with the client enterprise terminal 30 in a manner set forth above allows not only the diagnosis result coming from answer information replied by the human resource in response to the questions, to be taken as a human resource diagnosing factor but also the diagnostic evaluation of the human resource to be performed on the basis of static information of individual human resources, a field-evaluation given by a senior in the enterprise and the diagnosis result based on answer information.

One example of achieving such a human resource diagnosing method using the client enterprise terminal 30 is described in greater detail below. The presently filed example is described in connection with a situation where management of the employees of the enterprise is executed by the personal affairs staff, of the enterprise, that operates the client enterprise terminal 30.

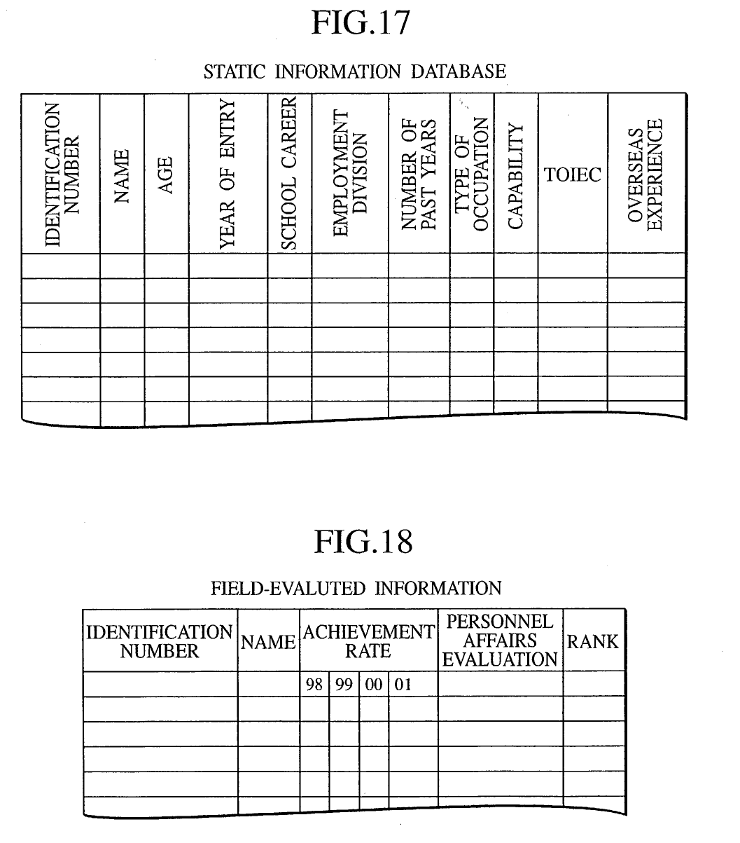

The client enterprise terminal 30 for use in such a human resource diagnosis support system includes an internal memory section that stores static information database shown in FIG. 17 and field-evaluated information database shown in FIG. 18. Also, while the present example is described in conjunction with an exemplary case where static information database and field-evaluated database that are stored in the client enterprise terminal 30, it is to be understood that static information database and field evaluated database may be stored in the human resource diagnosis support apparatus 20 and downloaded to the client enterprise terminal 30 to be provided to the personal affairs staff if desired.

As shown in FIG. 17, static information database includes information, such as an age, a year of entry, a school career, a division for employment, a year of experience, a type of business, a capability, TOEIC and an overseas experience, etc., in compliance with an identification number and the name for identifying the examinee, to be to be stored as static information.

Further, as shown in FIG. 18, field evaluated database includes information, such as an achievement rate indicative of the record of performance, a personal affairs evaluation evaluated by a senior in the enterprise and a rank, etc. in compliance with an identification number and a name, which are stored as field evaluated information.

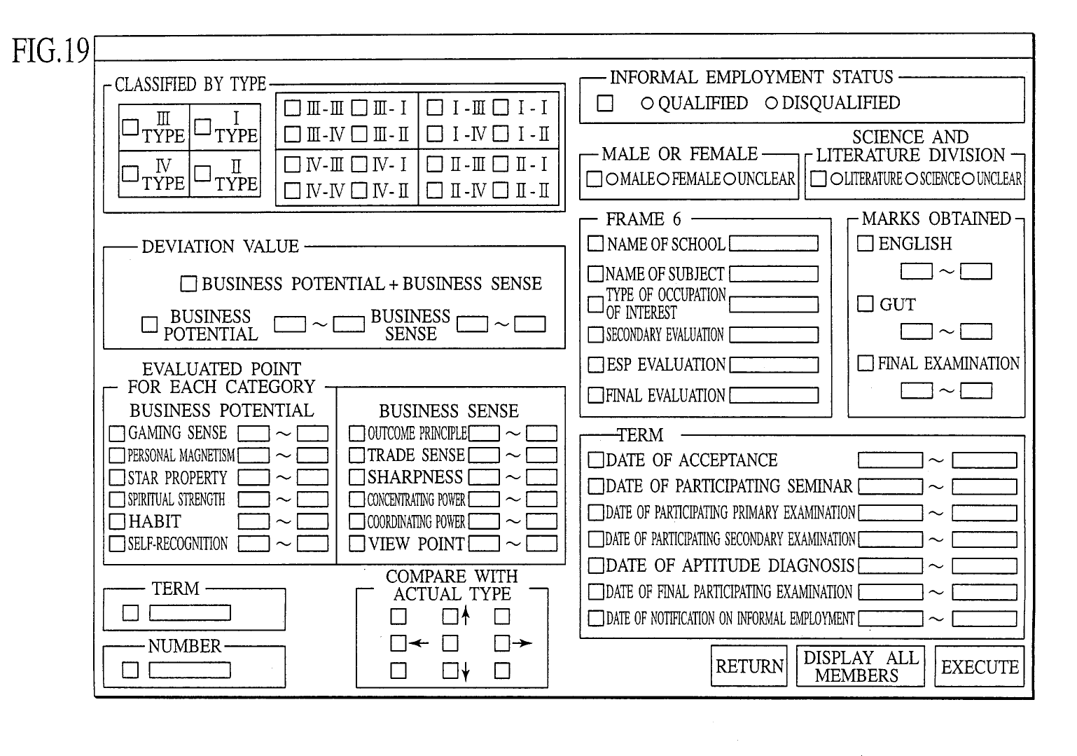

Then, if an operational input unit, such as a keyboard or mouse, of the client enterprise terminal 30 is operated with the personal affairs staff, a retrieving screen as shown in FIG. 19 is displayed over the display screen of the client enterprise terminal 30. The retrieving screen shown in FIG. 19 shows an example for selecting a retrieving condition to retrieve static information and field evaluated information related to the human resource stored in the memory unit of the client enterprise terminal 30.

As shown in FIG. 19, the retrieving condition includes an item classified by type, a deviation value in potential sense, an evaluated point for each category, a period in which the question is answered, an identification number, an informal decision status, a male or female, a science and literature division, a name of final school, marks obtained in English, etc., and a term in compliance with each region of the potential-sense shown in FIG. 16B. The display screen may be provided with a display for permitting a retrieving condition, which is not shown in FIG. 19, to be designated. By executing operational input through operation of the personnel affairs staff, a check box is designated, with the retrieving condition corresponding to the designated check box being selected.

Upon input of the plural retrieving conditions, the client enterprise terminal 30 operates to perform comparison between the plural retrieving conditions and the content of static information database, permitting a single screen to be provided in a list of the relevant examinees satisfying the retrieving conditions. Further, designating the check boxes not only for one person but also for a plurality of retrieving conditions allows comparison to be made between the plural retrieving conditions and static information database for providing a list of display for the relevant examinees.

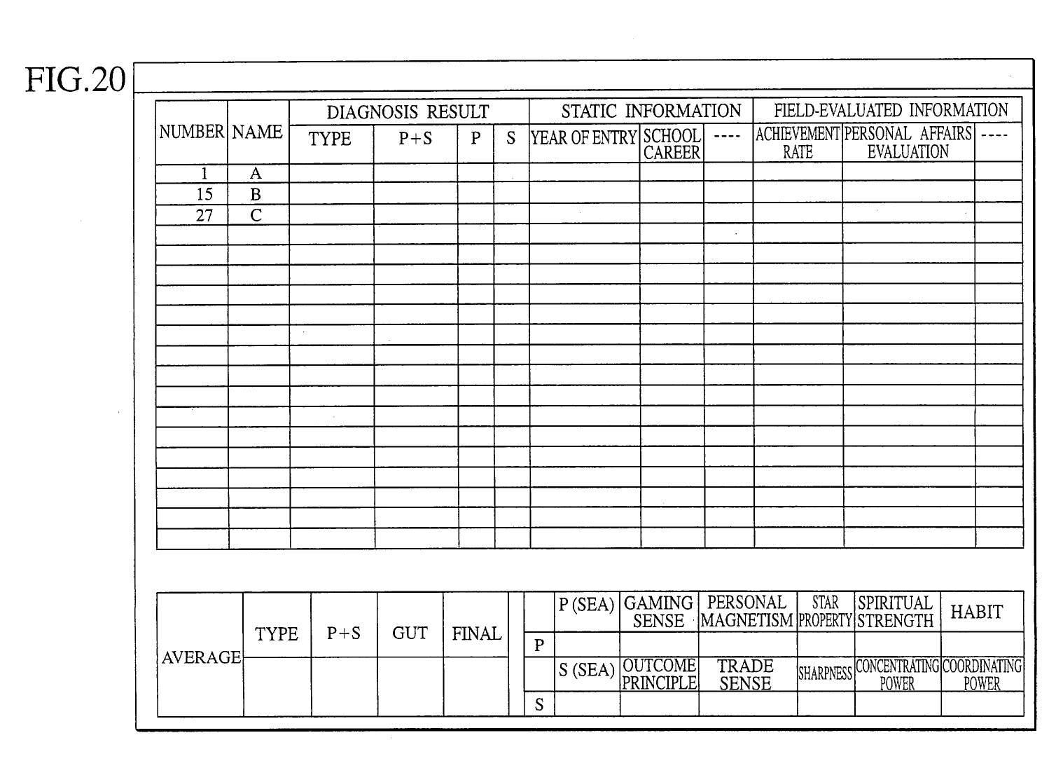

As shown in FIG. 20, if there are three examinees (for, instance, Number: 1, 15 ad 27, Name: A, B and C) who satisfy the retrieving conditions, the client enterprise terminal 30 provides a display of a list of diagnosis results, static information and field-evaluated information resulting from answer information given by the respective examinees, while permitting respective average values of the three examinees to be displayed. In this manner, a trend of the plural examinees satisfying the retrieving conditions can be provided to the personnel affairs staff. Also, in a case where there are plural relevant examinees satisfying the retrieving conditions, the client enterprise terminal 30 may provide a display of not only the various average values as shown in FIG. 20, but also a matrix, a ranking, a radar chart and a distribution representation for each category for each of the plural examinees.

In FIG. 20, further, the client enterprise terminal 30 may execute comparison between the diagnosis result based on answer information, and field-evaluated information in an actual practice to permit a comparison result to be provided. For instance, it is possible to implement comparison between the type, in compliance with each region of the potential sense in the diagnosis result based on answer information, and the type in the field-evaluated state to permit a comparison result to be provided.

Further, the client enterprise terminal 30 may be configured to provide a single screen for displaying the average value of the evaluated point for each category of the plural examinees provided in the list of display, a graphic chart plotted in compliance with the retrieving conditions, a ranking representation of the plural examinees, and a distribution chart as shown in FIG. 16C.

In such a manner, with the human resource diagnosis support system, the personnel affairs staff can be provided with a feature of static information of the single or plural examinees relevant to the retrieving conditions, a feature of field-evaluated information, and a feature based on answer information so as to support the personnel affairs staff for diagnosing the human resource, thereby supporting the personnel affairs staff to obtain the human resource desired by the enterprise in a short period of time.

In addition, when re-posting or re-assigning a new talent into a group (organization) or when re-posting or re-assigning the talents between different groups in the same enterprise, the human resource diagnosis support system is able to provide a variation in human resource diagnosing factors appearing before and after re-posting or re-assigning the human resource.

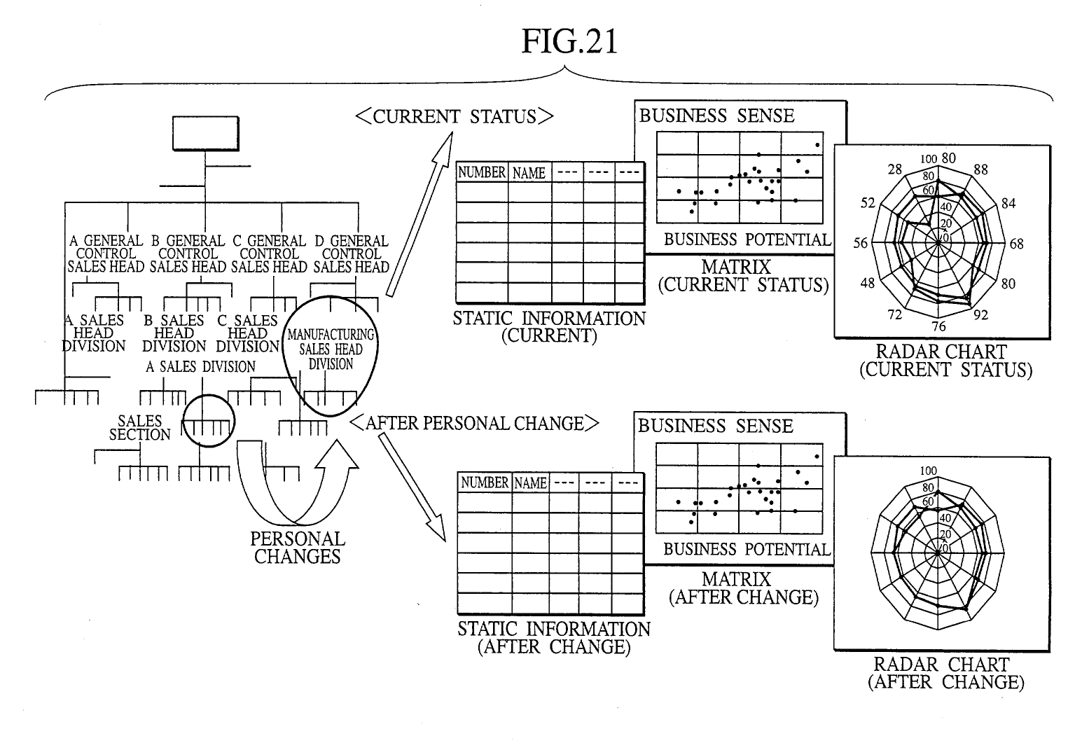

More particularly, in a case where the company has an organization defined in a tree form, as shown in FIG. 21, the client enterprise terminal 30 is arranged in a configuration where the presently filed example is shown as including “A” to “D” general control sales heads and, in a lower class, there are A to C sales head divisions and a manufacturing and sales head division. Here, a plurality of human resources belong to each general control sales head and each sales head division and, for each division, there are static information of the plural human resources in posts, a matrix, and a radar chart wherein the talent diagnosing factors of the plural talents forming the several divisions are averaged. With such an arrangement, the human resource diagnosis support system is enabled to provide the personnel affairs staff with the human resource diagnosing factors such as the average values of static information for each section to support the diagnosing operation for each group.

Under such a condition, in a case where personal changes are conducted by the personnel affairs staff to assign a staff belonging to an “A” sales section to the manufacturing sales head division, for instance, executing operation to drug the staff belonging to the “A” sales section to the manufacturing sales division allows static information, the matrix and the radar chart to be altered as a result of participation of the staff who has moved to the manufacturing sales division. As such, the personnel affairs staff can be provided with the matrix and the radar chart, that would appear when the staff is provisionally re-assigned, and the personal balance in each division after the personal change such that an index is provided for the personal change. This results in contribution to the maximum utilization of the human resources in the enterprise, with a capability of realizing a further intensification in an organizing ability of the enterprise.

Further, in a case where the staff is re-posted in the enterprise from, for instance, the “A” general sales division to the “B” general sales division, the personnel affairs staff can be provided with a first variation in the human resource diagnosing factors, of all the members in the “A” general sales division with the number of staffs being decreased, and a second variation in the human resource diagnosing factors, of all the members in the “A” general sales division with the number of staffs being increased, with a resultant contribution to the maximum utilization of the human resources in the enterprise while realizing a further intensification in an organizing ability of the enterprise.

Furthermore, with the human resource diagnosis support system, for instance, in a case where a fresh staff participates in the “A” general control sales division, the personnel affairs staff can be provided with a variation in the human resource diagnosing factors of a whole of the “A” general control sales division in combination with static information resulting from the answers to the questions. This results in contribution to the maximum utilization of the human resources in the enterprise at a stage when re-posting or re-assigning the human resources in the enterprise while enabling realization in a further intensification of the organizing ability.

In addition, further, the human resource diagnosis support system allows the answers to the questions to be regularly obtained from the human resources belonging to the enterprise to periodically provide the personnel affairs staff or an executive with diagnosis results for thereby permitting the enterprise to reconsider the members in the enterprise or to encourage the group (or the organization) to periodically conduct the diagnosing operation of the human resources within the organizations, that varies on a change with the passage of time, resulting in a further encouragement in an effective utilization of the human resources.

Moreover, the human resource diagnosis support system has a capability in that when starting up a new project in the enterprise, the human resources suited for the new project are retrieved based on the diagnosis results, static information and field-evaluated information resulting from the answers with respect to respective questions whereby the human resources suitable for carrying out the new project can be selected with mutual congenialities among the human resources being taken into consideration, resulting in a contribution to the maximum utilization of the human resources in the enterprise.

In addition, the human resource diagnosis support system has a capability of deploying a tolling business for a human resource who desires to be employed as a fresh graduate by providing an enterprise with questioning information, to allow the human resource, who seeks to be employed as the fresh graduate or in a midway, to compel them to reply their answers to the enterprise, while providing diagnosis results to the enterprise.

Further, the human resource diagnosis support system has a capability of deploying a business for tolling to the enterprise for a service of providing the enterprise with evaluations of human resources belonging to the enterprise by providing the human resources belonging to the enterprise with questioning information to provide a personnel affairs staff or an executive of the enterprise with diagnosis results.

Furthermore, the human resource diagnosis support system has a capability in that when the enterprise obtains answers with respect to the same questions raised to a plurality of human resources engaged with the enterprise for implementing evaluations of individuals, it is possible to deploy a tolling business for a license of software, to simulate the diagnosis results based on the answers, on a yearly contract basis or a monthly contract basis, or a tolling business that charges the enterprise on the basis of the number of human resources of which diagnosis results based on the answers are provided.

Moreover, the human resource diagnosis support system is advantageous in that the personnel affairs staff or the executive of a particular enterprise can be provided with human resource evaluations in the own company in terms of human resource evaluations in a plurality of enterprises upon receiving the answers in reply to the same questions raised to the plurality of the enterprises whereby the particular enterprise can be provided with comparison result between the human resources in the other enterprise ad the human resources belonging to the own company to allow the personnel affairs staff or the executive of the enterprise to obtain a market evaluation of the own human resources.

Further, more particularly, the human resource diagnosis support system enables comparison between the human resources of a whole of, for instance, a banking business field covering the plural enterprises, and the human resources belonging to the own banking business related companies, thereby enabling the personnel affairs staff or the executive to perform evaluation of the human resources with respect to the same business field.

In addition, with the human resource diagnosis support system, it is possible to deploy a tolling business for an optional service in which evaluation is provided for each group (or each organization) involving a plurality of human resources designated in the enterprise.

Further, with the human resource diagnosis support system, it is possible to deploy a tolling business for a service of providing the enterprise with database, in a unitary management, resulting from the diagnosis results based on the answers in reply to the questions, static information, field-evaluated information, various examinations such as linguistic ability tests.

Furthermore, with the human resource diagnosis support system, when carrying out the personnel change in the enterprise as show in FIG. 21, it is possible to further deploy a tolling business for a service to provide a variation in the diagnosis results for varying group (or organization).

While, in the exemplary embodiment set forth above, the present invention has been described with reference to a case where the resulting diagnosis result is transmitted to the client enterprise terminal 30, the client company terminal 30 may be modified so as to store a program for executing the operation, which the diagnosis functioning section 22 performs, to allow static information, field-evaluated information and the answers in reply to the contents of the questions to be downloaded to the client enterprise terminal 30 on demand to cause the diagnosis result to be produced.

Further, while the presently filed example set forth above has been described in connection with a case where the diagnosis result is provided in response to a deviation value resulting from the answers in reply to the questions, the diagnosis result may be produced not only on the basis of the deviation value but also on an evaluated point resulting from the answers with respect to the various examinations and, further, even when producing the diagnosis result on the basis of the total of marks of the answers in reply to the questionnaires, it is of course possible for the present invention to have the same effect as that set forth above.

Industrial Applicability

According to the present invention, since static information, indicative of information forming human resource diagnosing factors of an examinee for an objective to be diagnosed, and field-evaluated information indicative of evaluation, of the examinee in an enterprise and forming the human resource diagnosing factors are preliminarily stored whereupon inputting a plurality of retrieving conditions allows comparison between static information and field-evaluated information to be conducted to provide a single screen with a list of display of names of examinees in compliance with static information and field-evaluated information that satisfy the retrieving conditions, and static information and field-evaluated information of the relevant examinee, and a display of an average value of the human resource diagnosing factors of at least one of the examinees provided in the list of display, a human resource diagnosis result can be provided to a personnel affairs staff in a comprehensible display to allow the personnel affairs staff to have a precise diagnosis result to obtain a human resource desired by the enterprise in a short period of time.

Further, according to the present invention, the human resource diagnosing factors for a group involving a plurality of human resources can be provided and, for instance, it is possible to provide a variation in diagnosing factors of participating members when starting up a new project in the enterprise and provide a variation in the diagnosing factors of the group in a case where a new staff is participated in the group of the enterprise or in a case where the number of staffs is decreased in the group.

Furthermore, the present invention concerns to a capability of preliminarily storing a limited human resource average value that is an average resulting from quantification of answers to questions raised to a plurality of limited human resource, calculating a deviation value of a total value of the examinees with respect to the limited human resource average value, preparing the diagnosed result with the plurality of limited human resource and the talents being contrasted with respect to one another and providing the personnel affairs staff of a client enterprise, registered via a communication network, with the diagnosed result, enabling the client company to be provided with the precisely diagnosed result to allow the human resource desired by the enterprise to be adopted in a short period of time.

1. A method of supporting a human resource diagnosis, comprising the steps of:
preliminarily storing static information, indicative of information representing human resource diagnosing factors of an examinee for an objective to be diagnosed, and field-evaluated information indicative of an enterprise inside field-evaluation of an examinee in an enterprise and representing the human resource diagnosing factors;
inputting a plurality of retrieving conditions; and
comparing the plurality of inputted retrieving conditions with the static information and the field-evaluated information to provide a screen with names of relevant examinees in compliance with the static information and the field-evaluated information that match the retrieving conditions, a list of static information and field-evaluated information of the relevant examinees and an average value of human resource diagnosing factors of at least one of the relevant examinees provided in the list.

2. The supporting method according to claim 1, further comprising the steps of:
providing the screen with a list of the static information and the field-evaluated information associated with a an examinee selected from among a plurality of examinees, and a display of an average value of the human resource diagnosing factors of at least one of selected examinees; and
enabling selectable examinees to be altered for altering the list of static information and field-evaluated information and an average value of the human resource diagnosing factors of at least one of the examinees displayed in the list in response to the selectable examinees being altered.

3. The supporting method according to claim 1, comprising the steps of:
preliminarily storing static information and field-evaluated information of a plurality of examinees forming a group; and
providing an average value of human resource -diagnosing factors of at least one of the examinees displayed in the list.

4. The diagnostic evaluation supporting method according to claims 1 or 2, wherein when preliminarily storing a limited human resource average value, that forms an average resulting from numeric conversion of answers as a result of questioning a limited number of human resources, in storage means whereupon diagnosing the applicant in response to receipt of a diagnosing request from a client unit which is operated by the applicant via a communication network; the method comprising:
sequentially transmitting questionary information, indicative of the same questioning content as that of the questioning step, to the client unit and sequentially receiving a plurality of answers associated with the questionary information to convert the plural answers in a numeric value for calculating a sum value of the examinees; and
calculating a deviation value of the sum value of the examinees in terms of the limited human resource average value stored in the storage means and preparing a diagnosis result, contrasting the limited number of plural human resources and the examinee, to be stored as the human resource diagnosing factors.

5. The supporting method according to claim 4, wherein the step of storing the human resource diagnostic factors is executed by calculating evaluation points of a plurality of kinds in dependence on the answers from the applicants.

6. The supporting method according to claim 4, wherein the limited human resources include employees belonging to the client company and an average value resulting when numerically converting the answers as the result of questioning the employees are stored in the storage means as the limited human resource average value.

7. The supporting method according to claim 4, wherein the limited human resources includes human resources who have upper rank outcomes in a business field and an average value resulting when numerically converting the answers as the result of questioning the relevant human resources are stored in the storage means as the limited human resource average value.

8. The supporting method according to claim 4, wherein when executing the questioning step, questionary information for diagnosing a business potential and a business sense is provided to the applicant.

9. The supporting method according to claim 8, wherein the questionary information includes business potential diagnosing questions to enable diagnosis of the business potential, and sense diagnosing questions to enable diagnosis of the business sense, whereby when preparing the diagnosis result, a deviation value based on answers to the business potential diagnosing questions and a deviation value based on answers to the sense diagnosing questions are calculated whereupon the relationship between the deviation value of the business potential diagnosing questions and the deviation value of the sense diagnosing questions are plotted on a graph.

10. The supporting method according to claim 9, wherein the potential diagnosing questions include questions for each category to enable diagnosis of the business potential for each category, and the sense diagnosing questions include questions for each category to enable diagnosis of the business sense for each category such that when preparing the diagnosis result, a deviation value is calculated for each category on the basis of answers associated with the diagnosing questions for each category.

11. The supporting method according to claim 8, wherein the diagnosed result, represented in the graph indicative of the relationship between the deviation value of the business potential and the deviation of the business sense, and the diagnosis result inclusive of the diagnosis result obtained by calculating the deviation value for each category on the basis of the answers to the diagnosing questions for each category.

12. The diagnostic evaluation supporting method according to claim 4, wherein the storage means stores an average value of the answers, which are converted into a numeric value, obtained by implementing the questioning step in a past, an average value of the answers, which are numerically converted, obtained by implementing the questioning step for a limited human resource, and an average value of the answers, which are converted into the numeric value, obtained by implementing the above questioning step for a further limited human resource, with the diagnosis result being prepared using respective average values.

13. The supporting method according to claim 4, comprising the steps of:
storing information related to a registered client enterprise to be available for viewing with the client unit operated with the applicant; and
providing the enterprise, which the applicant desires to apply for, with the diagnosis result.

14. A human resource diagnosis support system, comprising:
storage means for storing at least static information, indicative of information representing human resource diagnosing factors of an examinee for an objective to be diagnosed, and field-evaluated information indicative of an evaluation of the examinee in an enterprise and representing the human resource diagnosing factors;
input means for inputting a plurality of retrieving conditions; and
providing means for comparing the plurality of input retrieving conditions with the static information and the field-evaluated information to provide a screen with names of relevant examinees in compliance with the static information and the field-evaluated information that match the retrieving conditions, a list of static information and field-evaluated information of the relevant examinees and an average value of the human resource diagnosing factors of at least one of the relevant examinees provided in the list.

15. The human resource diagnosis support system according to claim 14, wherein:
the providing means allows a screen to be provided with a list of the static information and the field-evaluated information of the applicants selected from among a plurality of examinees, and an average value of the human resource diagnosing factors of at least one of the selected examinees; and
the selectable examinees are alternated to permit the list of the static information and the field-evaluated information to be altered and an average value of the human resource diagnosing factors of at least one of the examinees displayed in the list in response to the selectable examinees being altered.

16. A human resource diagnosis support system having a human resource diagnosing support device, a client enterprise device and a client device, which is operated with an applicant seeking to apply to a client enterprise, that are connected to one another via a communication network, comprising:
a client device including operational input means to be operated with the applicant, transmitting and receiving means for transmitting and receiving information to and from the human resource diagnossis support system, and viewing means for viewing various information;
transmitting and receiving means for transmitting and receiving information to and from the client enterprise device and the client device, storing means for storing information related to the client enterprise, and viewing means and a client enterprise device to allow a client enterprise to view a diagnosis result diagnosed with the human resource diagnosis support device; and
a human resource diagnosis support device including transmitting and receiving means for transmitting and receiving information between the client device and the client enterprise device, storing means for storing a limited human resource average value that is an average value resulting from answers, that are converted into numeric values, obtained when applying questionary information indicative of questionary contents for diagnosing an applicant, client enterprise information related to the client enterprise and questions indicative of the questionary information to a limited number of plural human resources, and control means that sequentially transmits questionary information stored in the storing means in response to a diagnosis request from the client device and sequentially receives answers with respect to the questionary information to calculate an examinee sum value by numerically converting a plurality of answers for thereby calculating a deviation value of the examinee sum value in terms of the limited human resource average value stored in the storing means whereupon a diagnosis result with a contrast between the limited number of plural human resources and the examinee is prepared which is transmitted to the client enterprise device via the communication network.
